(19) United States
(12) Patent Application Publication
(10) Pub. No.: US 2003/0108704 A1
(43) Pub. Date: Jun. 12, 2003

(54) Resin composition, laminate and vehicular parts using same composition and production methods of them

(75) Inventors: Shoichiro Yano, Ibaraki (JP); Takashi Sawaguchi, Yokohama (JP); Masatoshi Chikazawa, Tokyo (JP); Takashi Takei, Tokyo (JP); Takashi Seino, Kanagawa (JP); Masao Nakajima, Chiba (JP); Tomohiro Ito, Kanagawa (JP); Yasuaki Kai, Yokohama (JP); Kouichi Handa, Kanagawa (JP); Shinkichi Torii, Kanagawa (JP); Katsuhiko Suzuki, Kanagawa (JP); Kenji Uesugi, Kanagawa (JP)

Correspondence Address: FOLEY AND LARDNER, SUITE 500, 3000 K STREET NW, WASHINGTON, DC, 20007, US

(73) Assignees: NISSAN MOTOR CO., LTD.; NIHON UNIVERSITY, SCHOOL JURIDICAL PERSON; TAMA-TLO CORPORATION

(21) Appl. No.: 10/284,179

(22) Filed: Oct. 31, 2002

(30) Foreign Application Priority Data
Oct. 31, 2001 (JP) 2001-334591
Jun. 27, 2002 (JP) 2002-188416

(51) Int. Cl. B32B 1/02

(52) U.S. Cl. 428/35.7

(57) ABSTRACT

A resin composition to be used as a material of a part of an automotive vehicle. The resin composition comprises a matrix resin. Linkages of inorganic fine particles are uniformly dispersed in the matrix resin. Each linkage has hydroxyl groups and hydrophobic groups which are introduced by a hydrophobicity-providing treatment. The linkages take at least one of a chain-like form and a net-like form.

### BACKGROUND OF THE INVENTION

This invention relates to a resin composition containing linked fine inorganic particles which impart an improved rigidity, a lower thermal expansibility and an improved surface hardness to a transparent resin without lowering its light transmittance, a laminate of high rigidity and improved surface hardness formed from it and realizing an improved appearance of a formed product by restraining any distortion thereof and a process for manufacturing the same, and they are suitable for application to e.g. the windowpanes of an automotive vehicle and its interior or exterior part.

The windowpanes of an automotive vehicle occupy a large portion of its outer surface area and are important parts for its driving and appearance. The appearance of various kinds of bent glass has brought about a greater degree of freedom in the selection of shapes and thereby an increase in the area of its use, and has been calling for a reduction in weight of a windowpane and an improved safety thereof. Various studies have, therefore, been under way to replace inorganic glass by a resinous window, but a resin is difficult to apply to a large windowpane, since it has a low elastic modulus as compared with inorganic glass.

The addition of glass fibers for reinforcing a resinous window improves its rigidity, but as they have a diameter of about 10 microns and a length of about 200 microns, they make the window opaque by reflecting visible light without transmitting it. Their use is, therefore, difficult for their failure to ensure visibility for safety.

Moreover, a resinous window is difficult to apply to the front window of a vehicle, since it is lower in surface hardness than inorganic glass, and is scratched if rubbed by a wiper. There has been a case involving the surface hardening treatment of a window with an organic silane type chemical, but its use has still been difficult because of its still unsatisfactory surface hardness despite such treatment, and since after a long time of use, it is scratched and becomes undesirably low in transparency.

A resinous window made by laminating an inorganic glass layer on a resin layer for improved rigidity and surface hardness has been difficult to employ, since in summer, the difference in thermal expansibility between the resin and glass layers causes their interfacial separation that disables any satisfactory visibility to be maintained through the window.

Silica sputtering has recently been employed for a resinous memory disk for an electronic device to harden its surface and improve its rigidity, but the deposition of silica atoms on a resinous base surface in a vacuum is inapplicable to any large part, and is low in productivity.

As a resinous window is lower in strength and rigidity than inorganic glass, its application to a large windowpane requires it to have a larger thickness than inorganic glass, resulting in its failure to realize any appreciable reduction in weight as expected. Thus, it has been a problem to improve the strength and rigidity of a resinous window.

As a solution to such a problem, Japanese Patent Provisional Publication No. 11-343349 describes a mixture of a transparent resin and fine particles of inorganic silica. When these resinous materials are applied to products, however, they have the advantage of being light in weight and allowing a high degree of freedom in the selection of shapes in molding as compared with the inorganic materials, but their drawbacks are a low rigidity due to a low elastic modulus, a reduction of quality in appearance due to distortion caused by the relaxation of the residual stress of the molding operation at a high temperature, and a low hardness making an easily damaged surface. Therefore, there is, for example, no transparent resinous material that is satisfactory in properties and adopted on a full scale for application to windowpanes occupying a considerably large area in the exterior surface of an automotive vehicle, though there is a material used for a small part which may be relatively low in rigidity and is easily capable of surface treatment, such as the headlamp or sunroof.

Referring to the resinous exterior or interior part of an automotive vehicle, other than the windowpanes, there is a demand of increasing severity for improvements in physical properties such as rigidity, weight, impact strength or deformation at high temperature and cost reductions, including a reduction of quality in appearance due to distortion, clearance narrowing, etc. caused by the relaxation of any residual stress at a high temperature, impact strength such as cracking resistance, and a reduction in weight of parts for an improved fuel consumption. Improvements by lamination have been under way in addition to any attempt relying upon a single resin alone for responding to such a demand for improvements in physical properties, since it has become difficult for any such attempt to satisfy all of the requirements increasing year by year. It is considered that lamination makes it possible to realize the desired functions by an effective combination of the properties owned by a plurality of resins and create a product of high added value at a low cost. Moreover, unitary molding including any surrounding part makes it possible to achieve a reduction in the number of parts and thereby in the cost of manufacture.

For an improvement in physical properties of such a laminate, Japanese Patent Provisional Publication No. 6-316045, for example, proposes a laminate of three kinds of transparent resins having an improved impact strength, but it is likely to show a reduction of quality in appearance due to unevenness caused by stretching at a high temperature in summer, or distortion caused by expansion when applied to the interior or exterior part of an automotive vehicle, since the maintenance of transparency does not allow the addition of any filler for restraining thermal expansion at an elevated temperature.

Japanese Patent Provisional Publication No. 11-343349 discloses a resinous window of a transparent resin containing fine particle silica having a particle diameter not exceeding the wavelength of visible light, and silica is mixed in the resin, or coats the surface of the window to improve its strength and rigidity, but as it is a single-layer structure, it has the disadvantages of, for example, lacking in resistance to any impact from outside and being distorted by thermal strain as a molded product.

Japanese Patent Provisional Publication No. 6-71826 discloses a resinous window made by laminating acrylic and polycarbonate resins, etc., but its thermal expansion is difficult to restrain satisfactorily, since the maintenance of transparency of the resins does not allow the addition of any filler for restraining their thermal expansion, as in the case of Japanese Patent Provisional Publication No. 6-316045. The maintenance of transparency does not allow the addition of any filler for improved rigidity, such as glass fiber, but an increased thickness is required for improved rigidity with a resultant increase of weight contrary to the desired weight reduction.

### SUMMARY OF THE INVENTION

Under these circumstances, it is an object of this invention to provide a resin composition which can realize a further improved rigidity and a reduction in thermal expansibility of a formed resinous product.

When an organic resin is used for making a large part, such as a windowpane, door, or body panel for an automotive vehicle, it is necessary to make any such part with a large thickness, since it is lower in rigidity than any inorganic material, and the use of resinous materials is not very effective for achieving a reduction of weight as an important object, though it may ensure a high degree of freedom in the selection of shapes in molding. It is, therefore, another object of this invention to provide a resinous material exhibiting improved rigidity without calling for any increase in thickness, and therefore making it possible to achieve a reduction in weight.

If a transparent resinous material is used for making a large part, such as a windowpane for an automotive vehicle, it is necessary to employ a structural design for relieving any surrounding steel part from thermal strain, since the material undergoes heavier thermal deformation due to the relaxation of the residual stress of the molding operation at a high temperature than any inorganic material. If the structure does not satisfactorily absorb any stretching caused by thermal deformation, a resinous pane may have a corrugated surface, or even crack. Thus, it is a further object of this invention to provide a resinous material that is less likely to be thermally deformed.

Moreover, a resinous material is lower in hardness than steel, and if it is used for making any part having a surface exposed to any contact by people, or any other different material, such as a windowpane, outer panel, interior decoration for an automotive vehicle or a building material, it is necessary to form a resinous surface having an improved scratch resistance. Thus, there is a demand for the provision of a resinous material having high rigidity, a low coefficient of thermal expansion and high scratch resistance, and capable of being shaped as desired in accordance with design data and at a low cost, and a process for manufacturing the same.

An aspect of the present invention resides in a resin composition comprising a resin. Linkages of inorganic fine particles are uniformly dispersed in the resin. Each linkage has hydroxyl groups and hydrophobic groups which are introduced by a hydrophobicity-providing treatment. The linkages take at least one of a chain-like form and a net-like form.

### BRIEF DESCRIPTION OF THE DRAWINGS

FIG. 1 is a microphotograph of linked fine inorganic particles of the net-like form, photographed through an electron microscope, the linked fine inorganic particles forming part of a resin composition according the present invention;

FIG. 2 is a schematic perspective view of an automotive vehicle whose exterior parts are formed using the resin composition according to the present invention;

FIG. 3A is a schematic perspective view similar to FIG. 1 but showing the automotive vehicle whose outer panels are formed using the resin composition according to the present invention;

FIG. 3B is a schematic plan view of the automotive vehicle of FIG. 3A;

FIG. 4 is a schematic perspective view of the automotive vehicle whose window is formed using the resin composition according to the present invention;

FIG. 5 is a schematic perspective view of a wiper system formed using the resin composition according to the present invention;

FIG. 6 is a schematic perspective view of an automotive vehicle whose exterior parts are formed using the resin composition according to the present invention;

FIG. 7 is a schematic perspective view of an instrument panel including a transparent portion and an opaque portion which are integrally formed using the resin composition according to the present invention;

FIG. 8 is a schematic plan view of an automotive vehicle which is provided with resinous mirrors and resinous windows which are formed using the resin composition according to the present invention;

FIG. 9 is a schematic cross-sectional view of a head lamp including a resinous lamp reflector formed using the resin composition according to the present invention;

FIG. 10 is a schematic fragmentary perspective view of an automotive vehicle, showing parts in an engine compartment which parts are formed using the resin composition according the present invention;

FIG. 11 is a schematic exploded perspective view of a mechanism in the engine compartment, the component parts of the mechanism being formed using the resin composition according to the present invention;

FIG. 12 is a schematic exploded perspective view showing resinous parts of a cooling system which parts are formed using the resin composition according the present invention;

FIG. 13 is a schematic exploded perspective view showing resinous parts of the cooling system which parts are formed using the resin composition according to the present invention;

FIG. 14A is a schematic perspective view of an automotive vehicle provided with exterior parts which have a hollow structure and are formed using the resin composition according the present invention;

FIG. 14B is a schematic perspective view of an automotive vehicle provided with exterior parts which have a hollow structure and are formed using the resin composition according to the present invention;

FIG. 15A is a schematic perspective view showing the inside of a passenger compartment of an automotive vehicle, provided with an interior part which is formed using the resin composition according to the present invention;

FIG. 15B is a schematic perspective view showing the inside of a passenger compartment of the automotive vehicle of FIG. 15A, provided with interior parts which are formed using the resin composition according to the present invention;

FIG. 16 is a schematic perspective view of an integrally molded product which is formed using the resin composition according to the present invention;

FIG. 17 is a schematic fragmentary perspective view of an upper part of an automotive vehicle provided with an integrally molded product which is formed using the resin composition according to the present invention;

FIG. 18 is a schematic perspective view of an integrally molded product which forms part of an automotive vehicle and formed using the resin composition according to the present invention;

FIG. 19A is a schematic vertical sectional view of a part of an automotive vehicle which part includes a movable portion and an unmovable portion which are formed using the resin composition according to the present invention;

FIG. 19B is a schematic transverse sectional view of the part of FIG. 19A; and

FIG. 20 is a schematic sectional view of a fuel supply system including various parts which are formed using the resin composition according to the present invention

### DETAILED DESCRIPTION OF THE INVENTION

According to a first aspect of this invention, there is provided a resin composition which comprises a matrix resin. Linkages of inorganic fine particles are uniformly dispersed in the matrix resin. Each linkage has hydroxyl groups and hydrophobic groups which are introduced by a hydrophobicity-providing treatment. The linkages take at least one of a chain-like form and a net-like form. In other words, the resin composition is a composite resin composition containing linked fine inorganic particles each of which inherently has hydroxyl groups at its surface. The each fine inorganic particle is subjected to a hydrophobicity-providing treatment so that the hydroxyl groups are partly substituted with hydrophobic groups. The linkages of fine inorganic particles are dispersed uniformly in the matrix resin. The linked fine inorganic particles are composed of a series of fine inorganic particles linked linearly to one another, and shaped like a chain, or a net. Thus, the linked fine inorganic particles form a moniliform body. The moniliform body forms part of at least one of chain-like form and net-like form. In order to obtain a resinous window of improved strength and rigidity, it has been assumed necessary to use highly strong and rigid molecules as the raw material of the matrix resin from the viewpoint of the molecular structure of the polymer of the matrix resin. However, the highly strong and rigid molecules are easily crystallized to result in a high degree of crystallinity which brings about a reduction in transparency. Therefore, according to the present invention, a measure for uniformly disperse linked fine inorganic particles (or the linkages of the fine inorganic particles) subjected to the hydrophobicity-providing so as to maintain the transparency of a (matrix) resin are employed for the purpose of improving the strength and rigidity of a transparent (matrix) resin.

The linked fine inorganic particles subjected to the hydrophobicity-providing treatment are composed of a series of fine inorganic particles linked linearly to one another, and shaped like a chain, or like a net under certain conditions. According to a common theory of fiber reinforcement, an improvement in tensile strength and elastic modulus of fiber is great when the fiber has a ratio of length and thickness equal to, or above a certain level, and when the fiber has its length extending in the direction of stress. In the case of a net, it shows isotropic strength characteristics, and produces the same results as an array of fibers extending in all the directions of stress.

The linked fine inorganic particles to be used in accordance with this invention preferably have a maximum length of not more than 380 nm, i.e. the wavelength of visible light, and more preferably from 28 to 350 nm to ensure transparency.

Each of the fine inorganic particles linked together forming the linkage has a thickness ranging from 1 to 20 nm and a length ranging from 7 to 700 nm. Each of the fine inorganic particles may be generally spherical. The linkage preferably has a length/thickness ratio of 2.5 to 350, in which each fine inorganic particle has a thickness of 1 to 20 nm and a length of 7 to 200 nm to achieve an improvement in strength and elastic modulus. The linked particles to be used according to this invention are preferably formed by a plurality of fine inorganic particles linked longitudinally and chemically to one another. The “length” of each fine inorganic particle means a longitudinal dimension of the same particle. The thickness of the linkage corresponds to the diameter or thickness of each of the fine inorganic particles linked together.

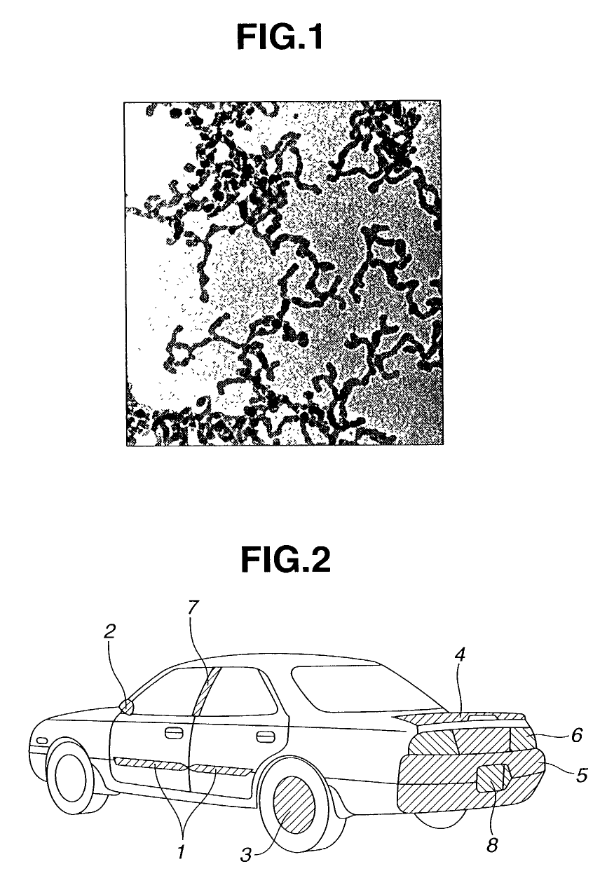

Silica, titania, zirconia, alumina, potassium titanate, whiskers, carbon nanotubes, synthetic mica, etc. are preferably used for the fine inorganic particles according to this invention, in which silica, or silicon oxide is, among others, preferable. Silica is transparent, has a low specific gravity and is easy to be modified at its surface to have an interaction with a resin. The linked fine inorganic particles can be produced by, for example, employing sodium silicate (Na₂O.SiO₂: water glass) as a raw material, removing sodium from it by ion exchange to form a nuclear sol (having a particle size of about 5 nm) and growing its fine particles alone in a liquid to form a 10 to 100 nm chain of silica particles. A net of silica particles can also be obtained during the growth of the fine particles. If the solution is concentrated, there is obtained colloidal silica as the linked fine inorganic particles shaped like a net, or a chain. Commercially available products can also be employed as fine inorganic particles, and it is preferable to use, for example, chain silica, such as Snowtex-UP of Nissan Chemical Industries, Ltd., or Snowtex-OUP obtained by removing sodium from it by ion exchange. FIG. 1 is an electron microphotograph of 200,000 magnifications for chain silica or the linkages of fine silica particles each of which is provided with hydroxyl groups and hydrophobic groups.

Although this invention is characterized by using linked fine inorganic particles subjected to hydrophobicity-providing treatment, such hydrophobicity-providing treatment is not specifically limited, but may be carried out by, for example, the alkylation of those particles with a silicone compound, such as trimethylchlorosilane or t-butyldimethylchlorosilane. If the particles are of silica, for example, alkyl groups are introduced by treating the hydroxyl groups of silica with a silylating agent, such as trimethylchlorosilane or t-butyldimethylchlorosilane. The silylating agent causes the removal of hydrochloric acid and promotes the reaction. The addition of amine may further promote the reaction by converting hydrochloric acid into hydrochloride.

The linked fine inorganic particles having alkyl groups introduced into their surfaces by the hydrophobicity-providing treatment have a good interaction with the functional groups in a (matrix) resin (e.g. polymethyl methacrylate) and are effectively dispersible in the resin to yield a resin composition of improved properties, such as transparency and rigidity. The selection of an adequate silylating agent for the hydrophobicity-providing treatment makes it possible to introduce an adequate hydrophobic group, such as alkyl, into the surfaces of the linked fine inorganic particles.

According to this invention, the resin in which the linked fine inorganic particles subjected to the hydrophobicity-providing treatment are dispersed is preferably selected from among oligomers of transparent organic polymers, such as acrylic, polycarbonate, polystyrene and polyolefin resins, or polymer or copolymer resins. They are high in transparency, and suitable for application to, for example, resinous windows.

The resin composition of this invention may contain 1 to 99% by weight of linked fine inorganic particles relative to or based on the weight of the resin in which the linked fine inorganic particles are dispersed. If their proportion is below 1% by mass, their presence is hardly effective, and if it exceeds 99% by weight, they may undergo coagulation to give an opaque resin composition.

Although there is no specifically limited process for manufacturing the resin composition of this invention, it can be manufactured in such a manner that the linked fine inorganic particles subjected to the hydrophobicity-providing treatment and dispersed in a solvent are mixed with a resin dissolved in a solvent. According to a second aspect of this invention, therefore, there is provided a process for manufacturing a resin composition as described above, which comprises mixing the linked fine inorganic particles subjected to the hydrophobicity-providing treatment and dispersed in a solvent with a resin dissolved in a solvent. If those particles are mixed in a powder form with the molten resin, they undergo coagulation and give an opaque resin composition. Therefore, the linked fine inorganic particles dispersed in a solvent are mixed with the transparent resin dissolved in a solvent to produce a mixed composition of both, upon adding a solidifying solvent, etc.

The solvent for dispersing the linked fine inorganic particles may be selected from among, for example, paraffin hydrocarbons such as pentane, hexane, heptane and octane; cycloparaffin hydrocarbons such as cyclobutane, cyclopentane and cyclohexane; and aromatic hydrocarbons such as methyl ethyl ketone, toluene, xylene, acetone and benzene. The concentration of the linked particles in their solution is not particularly limited, but from the standpoints of uniform mixing and easy work, it is preferably from 10 to 45% by weight.

The solvent for dissolving the resin depends upon the resin to be dissolved, and, for example, an aromatic or ketone type organic solvent, such as acetone, aniline, xylene, ethyl acetate, methyl acetate, butyl acetate, toluene or methyl ethyl ketone, is preferably employed for a (meth)acrylic polymer material containing methyl methacrylate, etc. as a principal monomer. According to this invention, the resin composition can be produced by kneading the solution of the resin and the linked fine inorganic particles, followed by removing the solvent. Alcohol, such as ethanol, methanol or buthanol, can be used as a solvent for solidification.

According to another preferred manufacturing process, the linked fine inorganic particles dispersed in a solvent are mixed with the resin during polymerization of the resin, followed by adding a solvent for solidification, thereby obtaining a mixed composition of those particles and the resin. According to a third aspect of this invention, therefore, there is provided a process for manufacturing a resin composition as described above, wherein the linked fine inorganic particles subjected to the hydrophobicity-providing treatment and dispersed in a solvent are mixed with the resin in the course of polymerization of the resin. More specifically, those particles are mixed with the resin monomers during the course of their polymerization to obtain a mixed composition of those particles and resin by using a solvent for solidification. This process enables the hydrophobic portions of those particles, such as alkyl groups, to interact with the functional groups in the resin (e.g. polymethyl methacrylate), so that the particles may be dispersed more uniformly than those mixed with the resin by dissolving in a solvent, and so that better properties may be obtained as required. The polymerization reaction may be carried out by suspension, solution, emulsion, bulk or precipitation polymerization. In the case of precipitation polymerization, however, it is necessary to choose a solvent not dissolving the polymer. For example, the solvent used in various processes as stated may be one for dispersing the linked fine inorganic particles, and dissolving a synthetic raw monomer and/or a polymer of acrylic, polycarbonate, styrene and/or polyolefin resin. If those particles have alkyl groups at their surfaces, the use of an organic solvent which can disperse those particles effectively and dissolve the monomer and the polymer makes it possible to obtain a good resin composition satisfying various items of requirements.

The resin composition of this invention may further contain any of various additives, such as an antistatic agent, an oxidation inhibitor, a heat stabilizer, an ultraviolet absorber, an anti-oxidant, a flame retardant, a pigment and a coloring agent which cannot lower the transparency of the composition, if required.

According to a fourth aspect of this invention, there is provided a thermoplastic resin laminate comprising at least one layer of each of a resin composition [hereinafter referred to also as the resin composition (A)] as described above and a thermoplastic resin [hereinafter referred to also as the resin (B)], the composition (A) and the resin (B) forming alternating layers. If the resin layers are bonded together by e.g. an adhesive, the characteristics of the individual layers are damped or absorbed by the adhesive layer, have only a lower effect on any adjoining resin layer and do not extend to the whole laminate. In the laminate of this invention, however, the resin layers are welded together by heat, the characteristics of the individual layers, such as rigidity, are utilized to cover their drawbacks, such as thermal deformation, to improve the rigidity of the laminate, so that it may be possible to restrain in the whole laminate any warpage caused by the relaxation of any residual stress in the layers at a high temperature.

A combination of layers containing different proportions of the linked fine inorganic particles (i.e., the linkages of the fine inorganic particles) in the resin compound (A) gives a laminate having a wide variety of characteristics. For example, a laminate has high impact and scratch resistance if its outermost layer contains a high proportion of the linked fine inorganic particles. If both of its uppermost and lowermost layers contain a high proportion of the linked fine inorganic particles, the laminate is of high rigidity and its upper and lower layers produce a binding force to restrain any thermal deformation by any residual stress at a high temperature. If its middle layer contains a high proportion of the linked fine inorganic particles, the laminate is of high rigidity and exhibits a greater force for restraining thermal deformation. If its upper layer contains a high proportion of the linked fine inorganic particles, while its lower layer contains a low proportion thereof, so that it may contain a varying proportion of the linked fine inorganic particles, the laminate has a varying distribution of rigidity which makes it possible to control the direction of any distortion caused by thermal deformation, though it may alternatively possible for the upper layer to contain a lower proportion of the linked fine inorganic particles. Thus, as the laminate is made by the heat welding of the resin composition (A) and the thermoplastic resin (B), it is possible to rely upon the characteristics of the individual layers for raising the elastic modulus of the laminate and improving its impact strength and rigidity, and if its outermost layer, or any adjoining layer contains a high proportion of the linked fine inorganic particles, the laminate has a high scratch resistance, while the formation of layers producing a binding force makes it possible to restrain any thermal deformation, overcome any surface roughening by distortion or deformation and improve the quality of its surface appearance. Moreover, the linked fine inorganic particles suppresses the thermal expansion of the resin layers and of the laminate as a whole. If the resin layers are not welded, but are bonded together by e.g. an adhesive, the characteristics of the individual layers are damped or absorbed by the adhesive layer, have only a lower effect on any adjoining resin layer and do not extend to the whole laminate.

The laminate may contain the linked fine inorganic particles in every layer, or only in a part of its resin layers, such as its surface (upper) or bottom (lower) layer. It is preferable for every layer to contain them for the improved rigidity of the laminate. It is also possible to vary their proportion from the upper to the lower layer, depending upon the purpose for which the laminate is intended. In any event, the laminate is of high rigidity, low thermal expansibility and improved scratch resistance and resists any distortion even at a high temperature if it is a thermoplastic resin laminate comprising at least one layer of each of the resin composition (A) and the thermoplastic resin (B), the resin composition (A) and the thermoplastic resin (B) forming alternating layers.

The thermoplastic resin (B) may be a polycarbonate resin, a styrene resin, poly-4-methylpentene-1, a thermoplastic polyurethane resin, etc., though a polycarbonate resin is, among others, preferred. The polycarbonate resin is a polymer derived from a divalent phenol compound, such as bisphenol A, and may be produced by a phosgene process, ester interchange, or solid-phase polymerization. It may not only be a known polycarbonate resin, but may also be a polycarbonate resin produced by polymerization in an ester interchange process.

The laminate has a thickness of 0.5 to 10 mm, and preferably 1 to 5 mm. With a thickness below 0.5 mm, the laminate may fail to retain its shape even if it may contain a higher proportion of the linked fine inorganic particles. With a thickness over 10 mm, the laminate may not have its middle layer bound effectively, but may be distorted at a high temperature and present a poor appearance. The resin layers in the laminate may each be of any suitable thickness selected from within the range stated above in accordance with the use for which it is intended, and the properties which it is required to have.

The laminate of this invention is preferably manufactured by forming under heat or pressure, though there is no particular limitation. According to a fifth aspect of this invention, therefore, there is provided a process for manufacturing a laminate by forming under heat and/or pressure. For example, a first process employs an extruder suited for the resin composition (A) and the thermoplastic resin (B), and comprises co-extruding molten resins into sheets through a T-die having a number of slits depending upon the number of layers to be formed, and welding every two adjoining resin layers together under heat. The extruder and T-die are held at substantially the same temperature, and though each sheet of the resin (B) or the resin composition (A) may have a very thin solidified film formed on its surface when all the sheets meet to form a laminate, the sheets have their surfaces melted again by the internal heat of the resin and have a mixed layer formed between every two joining surfaces by the diffusion of the composition (A) and the resin (B), so that the laminate may have its layers bonded together firmly.

According to a second process, single-layer sheets of the resin composition (A) and the resin (B), or a laminate as made by the first process is heated in a press machine having a heating plate, and is compression formed to form a laminate. The laminate of this invention can be made by compression forming a plurality of single-layer sheets together. According to the second process, it is preferable to insert a removable panel heater between every two adjoining surfaces, heat those surfaces into a molten state and remove the heater before compression forming.

A third process employs a two-color injection molding machine having a mold movable back and forth to define a cavity having a variable volume, and comprises injection molding a single-layer sheet of the resin composition (A), retracting the mold immediately, and during or immediately after the retraction of the mold, injecting the resin (B) into an empty cavity formed by its retraction. Although the resin composition (A) may have a very thin solidified film formed on its surface, the heat of the molten resin (B) injected thereonto melts the film again and the diffusion of the resin composition (A) and the resin (B) forms a mixed layer defining a strong joining surface therebetween. These steps are repeated to form a laminate having any desired laminated structure. If the mold temperature and the injection temperature of the resin are set 20 to 50 deg. C. higher than for any ordinary injection molding, the laminate has its layers welded together. A process which is suitable for the size of the laminate to be made, the number of layers to be formed, etc. may be selected from the processes as described.

The resin composition (A) and the resin (B) forming the laminate may further contain various additives, such as an antistatic agent, an oxidation inhibitor, a heat stabilizer, an ultraviolet absorber and a flame retardant, if they are required to make a laminate having their properties without lowering its transparency, and it is possible to make a laminate having a colored layer and a transparent layer if its lower layer is formed as a colored layer containing a pigment, or coloring agent, and is laminated with a transparent layer.

According to a sixth aspect of this invention, there are provided a molded product of the resin composition (A), or thermoplastic resin laminate as described above for an interior or exterior part of an automotive vehicle, an outer panel for the vehicle and a resinous window for the vehicle.

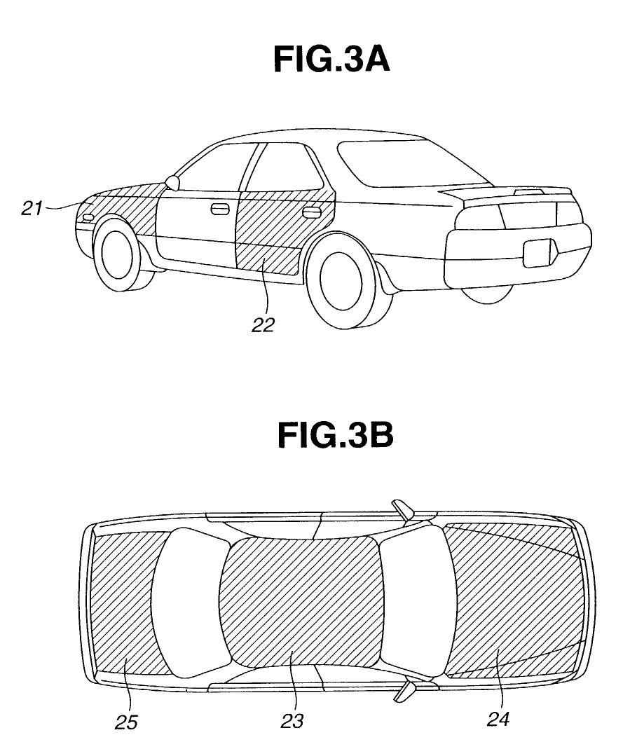

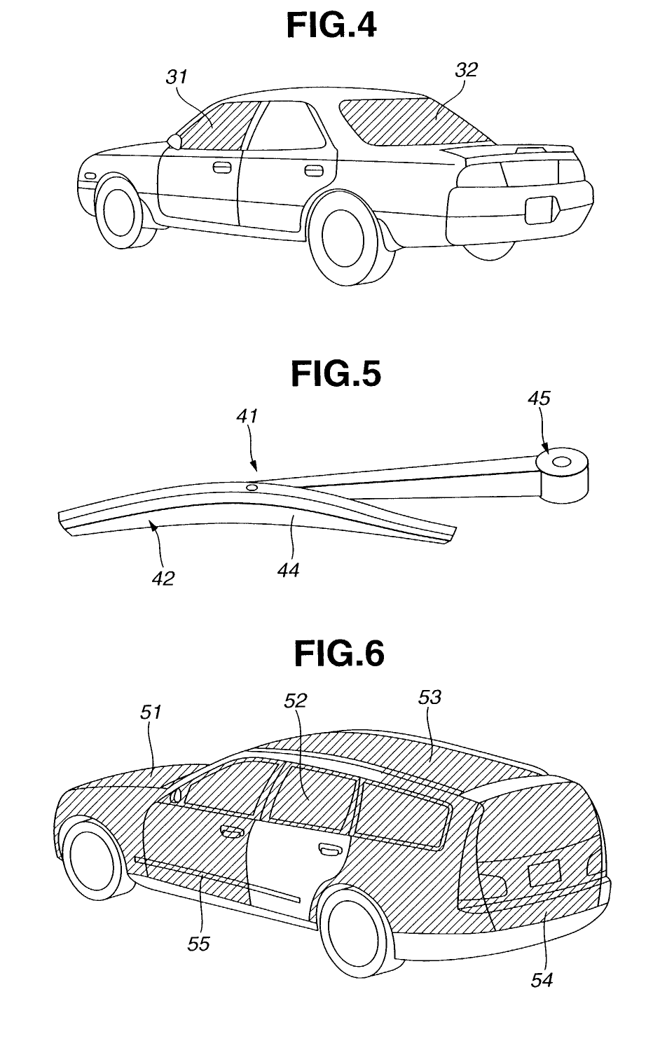

The resin composition (A) or laminate of this invention is suitable for making an exterior part of an automotive vehicle or its outer panel owing to its high transparency and rigidity, and its substantial freedom from any distortion even at a high temperature. For example, FIG. 2 shows molded parts forming the exterior parts of an automotive vehicle, including door moldings 1, frames 2 for door mirrors, wheel caps 3, a spoiler 4, bumpers 5, winker lenses 6, pillar garnishes 7, a rear finisher 8 and headlamp covers (not shown), and FIGS. 3A and 3B show outer panels for the automotive vehicle, including front fenders 21, door panels 22, a roof panel 23, a hood panel 24, a trunk lid 25 and back door panels (not shown). It is also applicable to a front windowpane not shown, side windowpanes 31 and a rear windowpane 32, as shown in FIG. 4.

According to this invention, it is possible to mix a coloring agent, such as a pigment, in the resin composition (A) or incorporate a colored layer in the laminate to make a product having any desired color tone, as stated above. The laminate of this invention may be a transparent one not containing any colored layer, or a laminate composed of transparent and colored layers. Therefore, it is useful for not only an automotive vehicle as explained above, but also for any other application calling for an appearance of high quality including pleasantness, smoothness and clarity, as well as high rigidity and scratch resistance, such as the preparation of any exterior or interior material of a building, or an interior material of a railroad car.

Any such product including a part for a vehicle, or a part forming an interior material of a building can be manufactured by any suitable process, such as injection molding, or vacuum and pressure forming, depending upon the product to be made. Although a common glass fiber-reinforced resin undergoes a gradual lowering in physical properties and is lowly recyclable, because of the destruction of glass fiber subjected repeatedly to shearing stress, the transparent resin composition (A) of this invention has only a limited degree of lowering in physical properties owing to the linked fine inorganic particles which makes it hardly susceptible to any shearing stress.

The laminate of this invention can also be formed by a known resin molding process, such as vacuum forming, vacuum and pressure forming, hot compression molding or blow molding, to make resin glass, an exterior part of an automotive vehicle, such as an outer panel, or an interior part. It is also possible to make a molded product forming an interior or exterior part of an automotive vehicle by injection or compression molding if the laminate is placed in a mold and if a resin is fed into the mold to form a unitary product with the outer periphery of the laminate. Unitary molding enables any intended product to be made without calling for any complicated process.

According to a seventh aspect of this invention, there are provided a resinous wiper system, a resinous door mirror stay and a resinous pillar each comprising the resin composition as described above. The resin composition of this invention is suitable for use in making any item required to ensure an improved visibility for a driver, such as a wiper system, or pillar, owing to its high rigidity, heat resistance, dimensional stability after heating or molding, and transparency.

A conventional wiper system has been made of steel having a black finish coating and black rubber, and has often lowered visibility when working at a low speed. Conventional door mirror stays have been formed from a resin having a finish coating in the same color with the outer plate, or a black color, and have often lowered visibility during a right or left turn of the vehicle. Conventional pillars have been of steel, and the front and center pillars have often lowered visibility when the vehicle is normally running, or makes a right or left turn, and the rear pillars when the vehicle moves back, or when the driver checks to ensure safety behind the vehicle. Although the use of a transparent resinous material for any such item improves visibility, it has been difficult to satisfy high rigidity, heat resistance and dimensional stability after heating or molding with any conventional transparent resinous material. The resin composition of this invention is a transparent material of high rigidity and low thermal expansibility or contractibility, and its use overcomes the above problems. The transparency of any such part contributes not only to its improved visibility, but also to its improved ornamental quality.

FIG. 5 is a diagram showing a wiper system by way of example. It has a wiper arm 41 and a wiper blade 42, and is movable along a half arc about a nut hole 45 for securing the wiper arm. Wiper blade 42 is usually composed of an elastic supporting portion 43 and a soft rubber portion 44, and the resin composition of this invention is used as a transparent material for at least one of the wiper arm, wiper blade and wiper blade supporting portion in a wiper system according to this invention. It is preferable to use, for example, silicone rubber having high durability and a relatively high transparency for the rubber portion in the wiper system of this invention. A resin composition obtained by adding an adequate amount of acrylic rubber to the resin composition of this invention may be used for making the wiper blade supporting portion. It imparts an adequate elasticity to the wiper blade supporting portion. An example of such a resin composition which is prepared by adding 1 to 30 parts by weight of acrylic rubber (whose main component is ethyl acrylate, butyl acrylate or a copolymer of the ethyl and butyl acrylates; e.g. Nipol AR31 of Nippon Zeon Co., Ltd) to 100 parts by weight of the resin composition according to the present invention.

The door mirror stay or the resinous pillar of this invention is not only a door mirror stay, or pillar molded from the resin composition of this invention as a transparent material, but may also be composed of a multi-layer laminate formed by laminating the resin composition of this invention with another resin. Such a laminate has at least one layer formed from the resin composition of this invention, and preferably has its outermost and lowermost layers, and more preferably a middle layer, too, formed from the resin composition of this invention. The multi-layer laminate has additional functions other than those given by the resin composition of this invention. The thickness of each individual layer in the laminate may be so selected as to suit the thickness of a final product and the number of the layers. A polycarbonate, polystyrene or a coplymer of styrene and methyl methacrylate may be used as another resin for forming such a laminate. The thermoplastic resin laminate of this invention can also be used as the multi-layer laminate. There is no particular limitation in a process for manufacturing a door mirror stay, or resinous pillar by using the resin composition of this invention or the multi-layer laminate as described. While it is possible to make a door mirror stay, or pillar as a discrete item, it is also possible to make it as a part of an integrally molded combination, such as a combination of a door mirror stay and a front pillar, or of a pillar and a resinous roof panel, by a process to be described later, if it is useful as a door mirror stay, or pillar.

According to an eighth aspect of this invention, there is provided a molded or formed resin product having a transparent portion and an opaque portion, at least the transparent portion containing the resin composition as described above. The resin composition of this invention is suitable for use in making an integrally molded resin product having a transparent portion and an opaque portion, owing to its high rigidity, heat resistance, dimensional stability after heating or molding, chemical resistance and transparency. The molded resin products will be described by reference to parts for an automotive vehicle.

An automotive vehicle contains a mixture of transparent parts, such as lamps, covers and panes, and opaque parts, such as outer panels and interior parts. It has been difficult to form a unitary combination of transparent and opaque parts from any conventional resinous material, since those parts are required to exhibit different properties including transparency, rigidity, heat resistance, low linear expansibility, low molding contractibility and chemical resistance. The resin composition of this invention is, however, easy to use for injection molding, or vacuum and pressure forming, and can be used as a transparent material for making an integrally molded or formed combination of transparent and opaque portions, while ensuring high rigidity, high heat resistance, low linear expansibility, low molding or forming contractibility and high chemical resistance, to thereby reduce the numbers of parts and process steps and decrease the weight of parts. The integral molding or forming of transparent and opaque portions combines the conventionally divided contour lines of any part into a single continuous line and thereby improves its outward appearance. More specifically, head lamps of which transparency is required are surrounded by other opaque parts, such as a bumper, a front grill, a fender and a hood. Their integral molding makes it possible to reduce the number of parts and thereby the number of steps in an assembly process. The resin composition of this invention is so high in heat resistance that there is no fear of the resin being melted by a nearby source of heat in a lamp. A conventional headlamp formed from a polycarbonate resin has called for a surface coating, since it is so low in light resistance as to undergo yellowing by exposure to sunlight. Such a problem can be overcome by using the resin composition of this invention.

There is no particular limitation in a process for manufacturing such a molded or formed resin product. Glass parts for an automotive vehicle are examples of parts of which transparency is required, and they are known as side and back door panes attached to the doors, rear quarter panes attached to the rear fenders and roof, and rear panes. The side or back door pane is of the construction having a sheet of glass disposed between the door outer and inner. It is possible to mold or form an integral combination of door outer and inner and glass by defining a hollow cavity between the door outer and inner, and pouring the resin composition of this invention into the cavity. It is possible to make an integral combination of a pillar garnish and a rear quarter pane in a similar way. Molded resin products according to this invention are shown in FIG. 6, and include not only an integral resin molded combination of pillar garnish and rear quarter pane as mentioned, but also an integral resin molded or formed combination 51 of lamp, hood and fender, an integral resin molded combination 52 of pillar garnish and pane, an integral resin molded combination 53 of roof, fender and pane, an integral resin molded or formed combination 54 of back door and pane and an integral resin molded combination 55 of door and pane. Door locks, a wiper motor, etc. may be installed in the hollows of the relevant parts later.

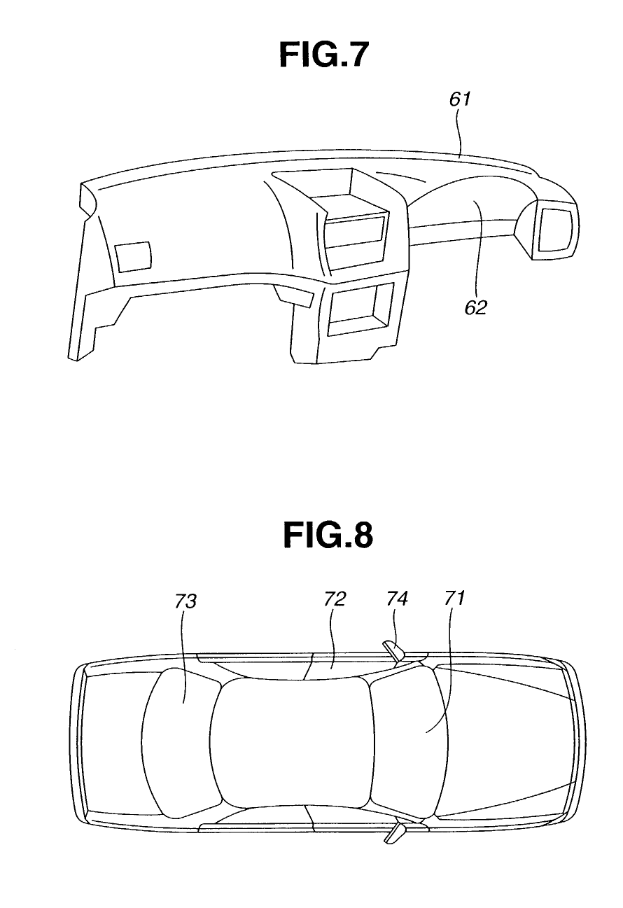

As regards an instrument panel in an automotive vehicle, it has been usual to prepare instruments, a transparent cover therefore and a cluster lid as separate parts. If an integral combination of transparent and opaque resin portions is molded by using the resin composition of this invention, it is possible to prepare an integral assembly of an instrument panel 61 and an instrument cover 62 and combine several kinds of parts into the instrument panel to thereby reduce the number of parts and achieve a weight reduction. Such an instrument panel is schematically shown in FIG. 7.

The resin composition of this invention can also be used to make a molded or formed resin product of high strength and rigidity having a transparent portion and an opaque portion. For example, the resin composition of this invention can be used to make a transparent roof portion without providing a glass sunroof. The opaque portion of any such molded product may or may not be colored.

The molded or formed resin product of this invention having a transparent portion and a colored opaque portion may be made by, for example, using a colored resin, painting or printing a color on the opaque portion, or employing a colored sheet of an opaque resin.

A colored resin may be prepared by dispersing a pigment in a resin, or by kneading a molten mixture of resin and pigment pellets and injecting it into a mold in an injection molding machine. Such a colored resin may be used to make a molded resin product according to this invention by opening the mold or forming a new molten resin passage, and injecting a molten transparent resin into the mold cavity through a separate cylinder. Thus, it is possible to make a molded resin product having a transparent portion and a colored opaque portion. Either a transparent resin or an opaque resin may be injected first.

An opaque portion colored by painting or printing may be formed by molding an intended resin product from a molten transparent resin and painting or printing the front or rear side of the molded product to color it and make it opaque. It is alternatively possible to paint or print a color before shaping a molten resin.

A colored sheet of an opaque resin may be used to make a molded resin product according to this invention by shaping a colored opaque resin sheet preliminarily, placing it in a mold, injecting a molten transparent resin into the mold, cooling the resin to solidify it and removing the whole from the mold.

The process described above makes it possible to produce, for example, an integral resin molded combination of roof, fender and pane not only in such a way that the pane is transparent, while the roof and fender are opaque, but also in such a way that an upper portion of the pane and a portion of the roof are transparent, while the fender and the remaining portions of the pane and roof are opaque.

Although the molded or formed resin product having an integral combination of transparent and opaque portions according to this invention can be formed from the resin composition of this invention and a pigment, it may also be composed of a multi-layer laminate formed by laminating the resin composition of this invention with another resin. Such a laminate has at least one layer formed from the resin composition of this invention, and preferably has its outermost and lowermost layers, and more preferably a middle layer, too, formed from the resin composition of this invention. The multi-layer laminate provides additional functions not achieved by the resin composition of this invention alone. The other resin forming the multi-layer laminate and the thickness of each layer may be so selected as to suit the purpose for which the molded resin product is intended.

According to a ninth aspect of this invention, there are provided a resinous window with a heating element or wire, a resinous mirror, a resinous lamp reflector, a resinous cover or case in an engine compartment, and a resinous part of a cooling system.

The resin composition of this invention is suitable for use in making parts, such as a window, a mirror, a lamp reflector, or a cover or case in an engine compartment, owing to its high rigidity, high heat resistance, dimensional stability after heating or molding, chemical resistance and transparency, and makes it possible to achieve a reduction in the numbers of parts and process steps and weight. The resin composition of this invention can be used as a transparent material to replace the material for any part required to be clear, so that its clouding may be prevented for improved visibility. For example, a resinous window, such as a front window 71, a door window 72 or a rear window 73 as shown in FIG. 8, is often provided in its molded product or on its surface with a heating element heater for heating it to prevent its clouding. Although a conventional transparent resinous material has presented problems of heat resistance and thermal expansion in the presence of heat by a heating element heater, no such problem occurs from the use of the resin composition according to this invention. Owing to its high rigidity, the resin composition of this invention is applicable to a large item, such as front window 71, door window 72 or rear window 73, to reduce its weight. A heating element heater may be formed by, for example, insert molding or forming a heating element prepared in film form, or forming a heating element on the inner surface of the window by vapor deposition, coating or printing. The transparent resin of this invention can also be used to make a side mirror 74 (See FIG. 8) which is lighter in weight than one of any conventional glass or transparent resin, and which can be equipped with a heat-ray heater to avoid clouding. It is also applicable to a room mirror in addition to the side mirror shown in FIG. 8.

FIG. 9 is a cross sectional view of a lamp for an automotive vehicle. A reflector 83 is mounted in an outer member 82 secured to a base 81 on the vehicle body, and a bulb 84 and an optical axis regulator 85 are connected to the reflector, while an outer lens 86 is fitted on the outer member. Although a reflector formed from any conventional resinous material has often been inferior in heat resistance, linear expansibility and linear expansion anisotropy, the use of the resin composition according to this invention overcomes those problems. Owing to its high rigidity, the resin composition of this invention makes a lamp reflector which is light in weight and high in heat resistance, as well as in dimensional stability and surface smoothness, and which is suitable as a reflector for a head, fog, or rear combination lamp, or a sub-reflector for a head lamp. Its reflecting portion may be formed by, for example, insert molding a reflecting film during the manufacture of the member, or forming a reflecting film by vapor deposition after injection or press molding the member.

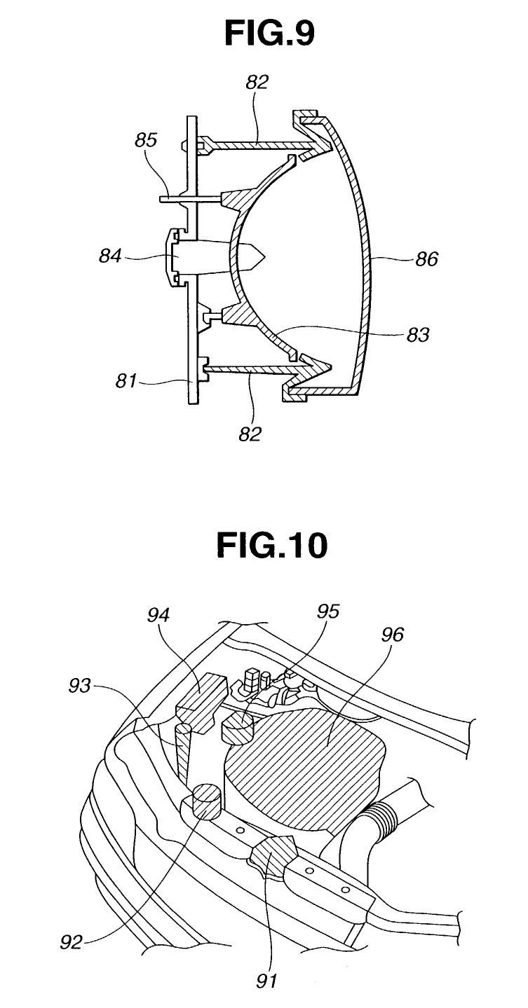

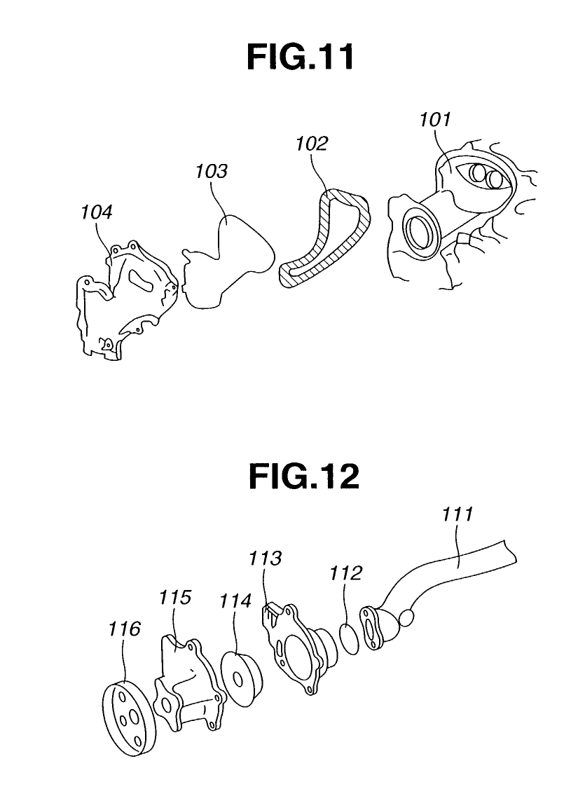

The resin composition of this invention is also applicable to covers or cases in an engine compartment. The inside of an engine compartment is shown in FIGS. 10 and 11. Owing to its high transparency, heat resistance, chemical resistance and rigidity, the resin composition of this invention can make various parts of light weight which can withstand use in an engine compartment having severe temperature conditions. Examples of such parts are a radiator 91, a coolant reservoir tank 92, a washer tank inlet 93, a housing 94 for electrical parts, a brake oil tank 95, a cylinder head cover 96, an engine body 101, a timing chain 102, a gasket 103 and a front chain case 104. Owing to its transparency, the resin composition of this invention improves the visibility of the inside of a tank or cover, such as the washer tank inlet, housing for electrical parts, brake oil tank, cylinder head cover, or timing belt cover.

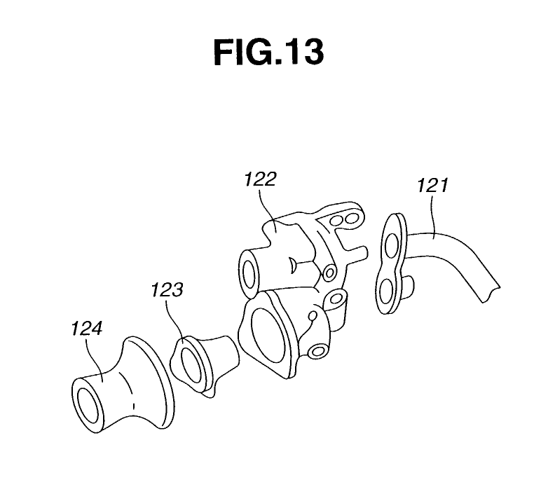

The resin composition of this invention can make parts of light weight and high heat and chemical resistance and rigidity which are suitable as parts used in contact with cooling water in an engine compartment for an automotive vehicle. Such resinous parts for a cooling system are shown in FIGS. 12 and 13. They are parts for the top and base of a radiator tank and valves, such as a water pipe 111, an O-ring 112, a water pump housing 113, a water pump impeller 114, a water pump 115 and a water pump pulley 116 which are shown in FIG. 11, and a water pipe 121, a thermostat housing 122, a thermostat 123 and a water inlet 124. The resin composition is of high value in practical use owing to a weight reduction, an improved chemical resistance and an improved fuel consumption.

Although every part described above can be formed from the resin composition of this invention alone, it may also be composed of a multi-layer laminate formed by laminating the resin composition of this invention with another resin. Such a laminate has at least one layer formed from the resin composition of this invention, and preferably has its outermost and lowermost layers, and more preferably a middle layer, too, formed from the resin composition of this invention. The multi-layer laminate provides additional functions not achieved by the resin composition of this invention alone. The other resin forming the laminate and the thickness of each layer may be so selected as to suit the purpose for which each part is intended.

According to a tenth aspect of this invention, there is provided an integrally molded or formed resin product comprising the resin composition as described above and having a hollow structure communicating with the open air and/or a closed hollow structure. Owing to its high rigidity, heat resistance and dimensional stability after heating or molding as stated, the resin composition of this invention is suitable for any part having a hollow structure, such as a door, roof or hood. Many of the parts forming the interior and exterior of an automotive vehicle have a hollow structure defined by steel plates and resin panels for accommodating an auxiliary device, etc. For example, a side or back door has a hollow structure formed by an outer and an inner steel plate, and has a resin panel attached to the inner steel plate during an assembly process after painting, while an auxiliary devices or devices are installed in the hollow structure. A roof, hood, trunk lid, or back door has an outer plate and a reinforcement formed from steel plates, and a resinous part attached to its inside after painting. All of these parts having a hollow structure have been difficult to mold of formed as unitary products from any conventional resinous material, since they are large and have to be of high rigidity and dimensional stability. The resin composition of this invention having high rigidity, low thermal expansibility and low thermal contractibility, however, enables the molding of any such part as a unitary product and thereby makes it possible to achieve a reduction in the number of the parts, the number of process steps and the weight of the parts.

Although the integrally molded or formed resin product of this invention can be formed from the resin composition of this invention alone, it may also be composed of a multi-layer laminate formed by laminating the resin composition of this invention with another resin. Such a laminate has at least one layer formed from the resin composition of this invention, and preferably has its outermost and lowermost layers, and more preferably a middle layer, too, formed from the resin composition of this invention. The multi-layer laminate provides additional functions not achieved by the resin composition of this invention alone. The other resin forming the multi-layer laminate and the thickness of each layer may be so selected as to suit the purpose for which each product is intended. The thermoplastic resin laminate of this invention can be used as such a multi-layer laminate.

The integrally molded or formed resin product of this invention has an improved commercial value if a skin, or an ornamental or decorative layer as formed by a printed design, is formed on its outermost layer to improve its design, feel and quality. For example, a molded product having a skin formed on its outermost layer by a napped sheet, a sheet having an embossed pattern, a sheet having a pattern formed by laser, or a sheet having a pattern like the grain of wood, is useful as, say, the inner portion of a roof, a pillar garnish, or an instrument panel. A multi-layer laminate as described above may have a printed design layer as its middle layer, and present a lustrous or deep appearance if its surface layer is formed from a transparent material.

The integrally molded or formed resin product of this invention having a hollow structure has an improved heat-insulating and sound-proofing property if its hollow interior is filled with a gas, liquid or solid, or a mixture thereof. The filling material is preferably a gas, such as nitrogen, argon, carbon dioxide or air, if transparency is required, and if no transparency is required, it is preferable to use not only any gas as mentioned above, but also paraffin or wax which is a liquid at an elevated temperature during filling, and a solid at a normal temperature thereafter. The filling material makes it possible to maintain a comfortable environment in a vehicle by restraining the escape of cool air from the vehicle and the infiltration of heat from outside in summer and the escape of warm air and the infiltration of cold air in winter. The double-wall structure having a hollow space therein damps or absorbs the energy of noise from outside, and ensures a calm environment in the vehicle. If such a structure is applied to a hood, it is possible to reduce any radiant noise and heat coming out from the engine compartment.

The integrally molded or formed product of this invention having a hollow structure can be made by employing, for example, a common vacuum and pressure forming, injection or blow molding, or press forming process without any particular limitation, and for example, the following processes will be suitable.

According to a first process, two resin sheets formed from the resin composition of this invention are fixed in a holder having a path for introducing a pressurized fluid, and the holder is sealed by a known method to form a closed space between the two sheets. The sheets are heated to at least their deflection temperature under load, and set in an open mold, and the softened sheets are welded together along their outer peripheral sections pressed together by the mold. A pressurized fluid is introduced into the closed space between the two sheets during their welding or thereafter, and during the expansion of the sheets or thereafter, the mold is closed and the pressure of the fluid is maintained until a molded product is cooled to form a hollow structure. The mold preferably has an evacuating hole for evacuating the space between the mold surface and each sheet to bring them into intimate contact with each other. Such evacuation gives a molded product of improved transferability. According to an eleventh aspect of this invention, therefore, there is provided a process for manufacturing an integrally molded or formed resin product which comprises heating two resin sheets containing the resin composition as described before, placing them in an open mold, introducing a pressurized fluid between the sheets before welding them together along their edges or thereafter, and closing the mold during the expansion of the sheets or thereafter, and maintaining the fluid pressure to form a hollow structure.

According to a second process, a closed mold is retracted to have its cavity enlarged, while it is filled with a molten resin composition according to this invention, or thereafter, and a pressurized fluid is introduced into the molten resin to form a hollow structure.

According to a third process, one or two resin sheets containing the resin composition of this invention are inserted along the cavity surface of an open mold, and while a molten resin is fed into the closed mold between the two sheets or behind one and the only sheet, or thereafter, a pressurized fluid is introduced into the molten resin to form a hollow structure, while the volume of the cavity is enlarged. More specifically, one resin sheet formed from the resin composition is inserted along the cavity surface on one side of an open mold, and while a molten resin is fed to fill the cavity behind the sheet, or thereafter, a pressurized fluid is introduced into the molten resin to form a hollow structure, while the mold is retracted to enlarge the volume of the cavity, or two resin sheets are inserted along the cavity surfaces on both sides of a mold, and while a molten resin is fed to fill the cavity between the sheets, a pressurized fluid is introduced into the molten resin to form a hollow structure, while the volume of the cavity is enlarged. The resin to be used to fill may be any resin adhering closely to the sheet or sheets containing the resin composition of this invention, and preferably having a solubility parameter (SP) close to that of the resin composition of this invention. It is possible to use as such one or more of the thermoplastic resins (B) employed in the thermoplastic resin laminate as described before.

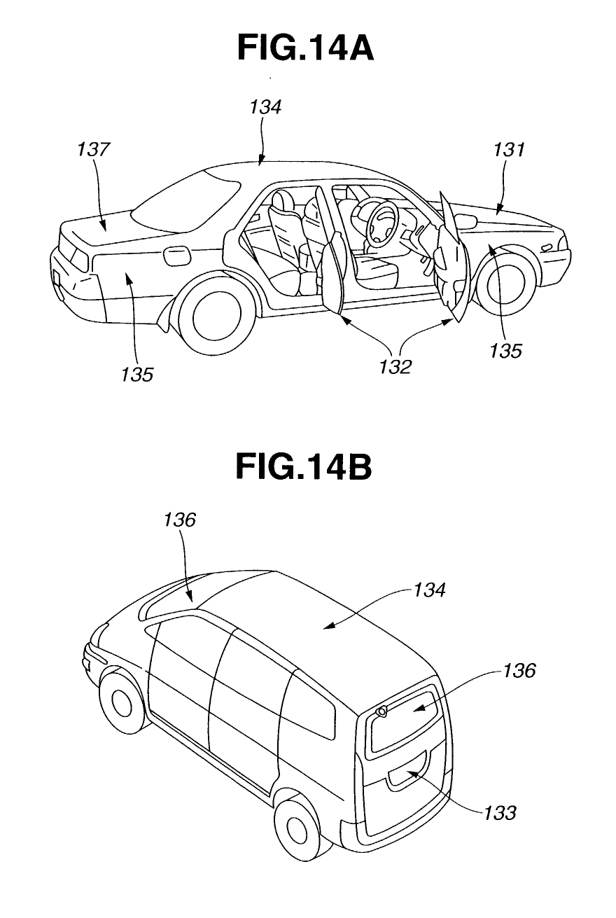

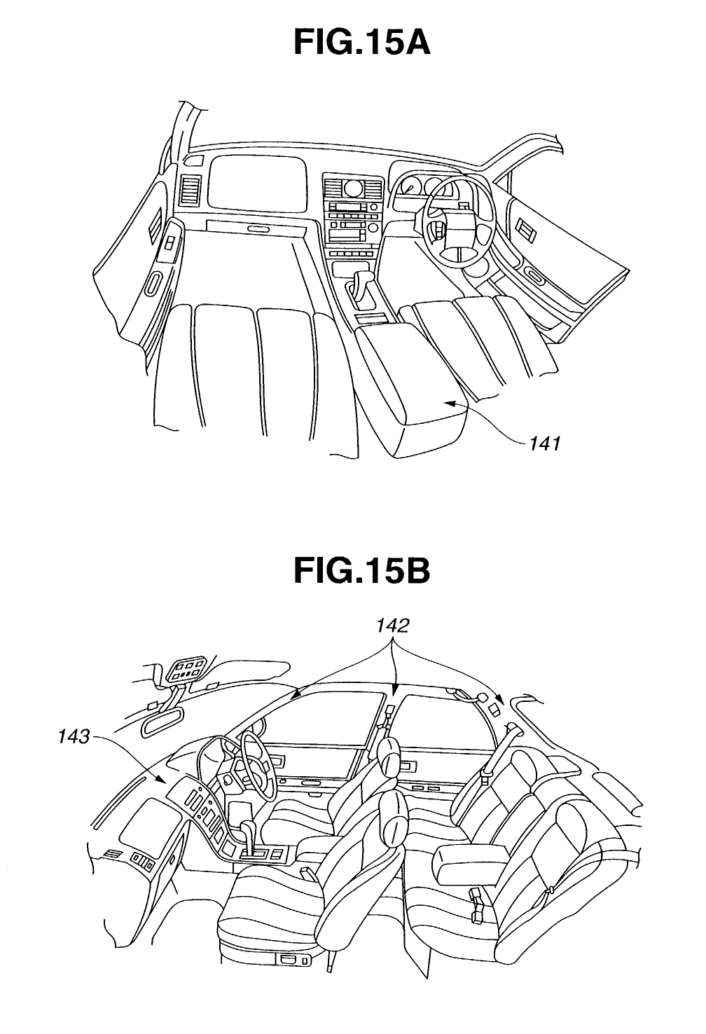

The integrally molded or formed resin product of this invention having a hollow structure is applicable to, for example, a hood 131, a door 132, a back door 133, a roof 134, a fender 135, a window 136, a trunk lid 137, a center console box 141, a pillar garnish 142, an instrument panel 143, or a head lining, as shown in FIGS. 14A and 14B or FIGS. 15A and 15B. Any of these parts can be molded or formed with an inner or outer, an auxiliary part, or a reinforcement to make a unitary combination to thereby reduce the number of parts and process steps. Moreover, a hollow part filled with a gas, liquid, or solid, or a mixture thereof can be used to perform additional functions. For example, the hood can be combined with a reinforcement, and can be used to perform sound-proofing and heat-insulating functions, and the roof can be combined with a head lining, and can be used to perform heat-insulating and sound-proofing functions, while each door or fender can be combined with an inner and an outer.

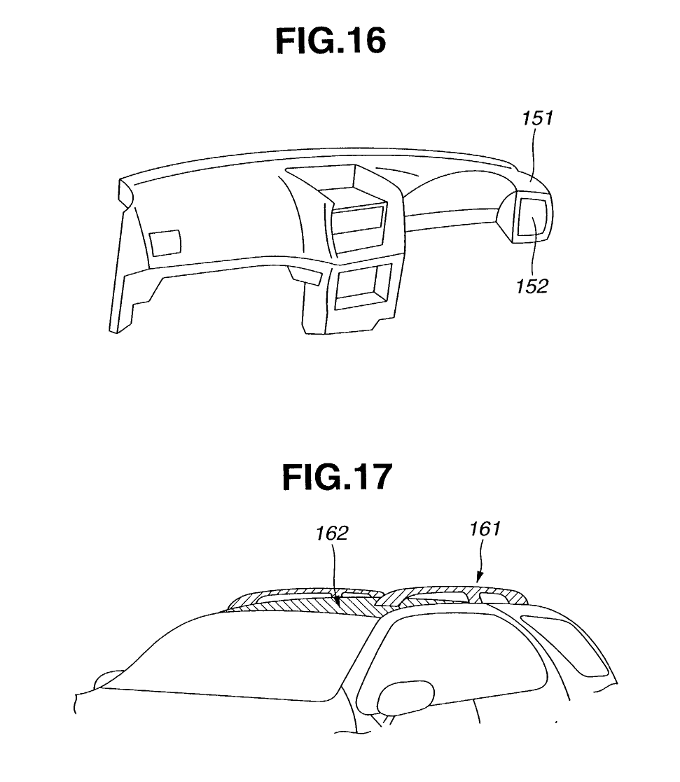

According to a twelfth aspect of this invention, there is provided an integrally molded or formed product formed from the resin composition of this invention and combining two or more kinds of parts having different functions to form a single part having at least two such functions. Examples of the different functions are the function of a display as of an instrument panel, the function of ventilation as of an air conditioner duct, and the function of fixing as of a roof rail. Owing to a broad range of properties including high rigidity, high heat resistance, dimensional stability after heating or molding, and chemical resistance, the resin composition of this invention is applicable to various parts expected to perform various functions and can be used to make an integrally molded product combining two or more kinds of parts having different functions to form a single part having at least two such functions. It is, therefore, suitable for making a large part in a module, or an integrated form to reduce the number of parts and process steps and the weight of parts, while retaining high quality. For example, FIG. 16 shows an instrument panel as a large part for the interior of an automotive vehicle, and it is usual practice to prepare a panel 151, an air duct and case 152 for an air conditioner and a cross car beam (a steering cross member) separately and put them together in a vehicle manufacturing line. It has been difficult to mold an integral combination of the panel and the air duct and case for an air conditioner from any conventional resinous material, since it results in a large and complex shaped product which is likely to shrink or warp during molding, or expand under heat, but these problems can be overcome if the resin composition of this invention is used. Owing to its high rigidity, the resin composition of this invention can combine those parts into a unitary structure, while eliminating any cross car beam (steering cross member) that has hitherto been made of steel. The resin composition of this invention can also combine a bracket, or the like that would have had to be prepared separately if it had been made of steel. It also enables a unitary combination including a skin, or like ornamental material to be made by insert molding. Similar results can also be obtained from its application to, for example, a door. A door inner panel is presently mainly of steel, and is assembled with various other parts, such as a side window guide rail, a regulator, a door lock and a speaker, in a manufacturing line. The resin composition of this invention can combine a door inner panel, a guide rail, a speaker housing, etc.

FIG. 17 shows another example of an integrally molded assembly according to this invention. FIG. 17 shows roof rails 161 as large parts for the exterior of an automotive vehicle which are combined with a roof panel 162 formed from the resin composition of this invention. The roof rails have been difficult to form from any conventional resinous material because of rigidity and heat resistance, since they have to bear a heavy weight and are likely to be exposed to severe temperature conditions. These problems can be overcome by the resin composition of this invention. Similar results can be obtained from its application to, for example, a spoiler, as a spoiler can be combined with a trunk lid formed from the resin composition of this invention.

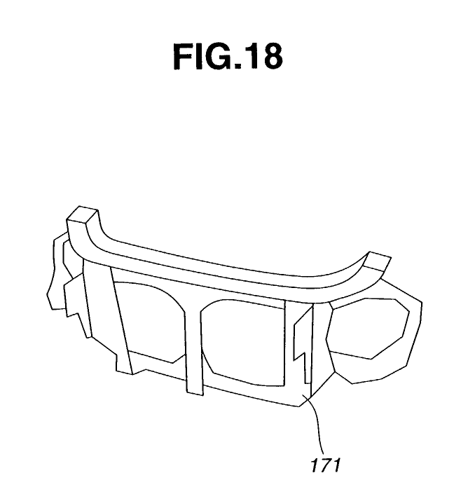

FIG. 18 shows a radiator core support as a large vehicle part 171. Although a resinous radiator core support 171 is appearing as a front end module, the resin composition of this invention can make a part of higher heat resistance, chemical resistance and rigidity and lighter weight, and combine it with a fan shroud, a bracket, etc. The resin composition of this invention can combine transparent parts, such as a radiator reservoir tank and a headlamp cover, as well as a bumper reinforcement which has hitherto been a separate member. Owing to its high heat and chemical resistance and low linear expansibility, the resin composition of this invention is useful for combining parts in an engine compartment, such as an air cleaner and a throttle chamber. Although attempts have already been made to realize an integral combination of those parts, the engine compartment creates a severe environment by a high temperature and the presence of oil and other chemicals, and presents problems yet to be overcome by any conventional resinous material, but those problems can be overcome by the resin composition of this invention. Similar results can be obtained from its application to an intake manifold and a cylinder head cover, and they can be combined with the parts mentioned above.

Although the integrally molded or formed combination of this invention can be formed from the resin composition of this invention alone, it may also be composed of a multi-layer laminate formed by laminating the resin composition of this invention with another resin. Such alaminate has at least one layer formed from the resin composition of this invention, and preferably has its outermost and lowermost layers, and more preferably a middle layer, too, formed from the resin composition of this invention. The multi-layer laminate provides additional functions not achieved by the resin composition of this invention alone. The thermoplastic resin laminate as described before can be used as such a multi-layer laminate.

Owing to its high rigidity, heat resistance and dimensional stability after heating or molding, the resin composition of this invention is suitable for an integrally molded combination including a part having a movable portion and an unmovable portion, such as a throttle chamber. Many parts having movable and unmovable portions are used in an intake or exhaust system or an air conditioning unit in an automotive vehicle. These parts are mainly intended for controlling the flow of gas, such as air, and each part is composed of a cylindrical portion defining a gas passage and a cover which can be opened and closed to control the flow of the gas, and gas tightness is important for any such part, as is the case with, for example, each door for a throttle chamber or in an air conditioning unit. The cylindrical and cover portions of any such part formed from any conventional resinous material are so low in dimensional accuracy because of high degrees of molding shrinkage and thermal expansion that the cover portion is unsatisfactory in gas tightness. Heat resistance has been another problem imposed by any part for installation in an engine compartment. Owing to its low thermal expansibility and contractibility, and high heat resistance, the resin composition of this invention can overcome those problems and make a part of high gas tightness. Owing to its high rigidity, the resin composition of this invention can also achieve a reduction in weight of any such part and a corresponding improvement of its response.

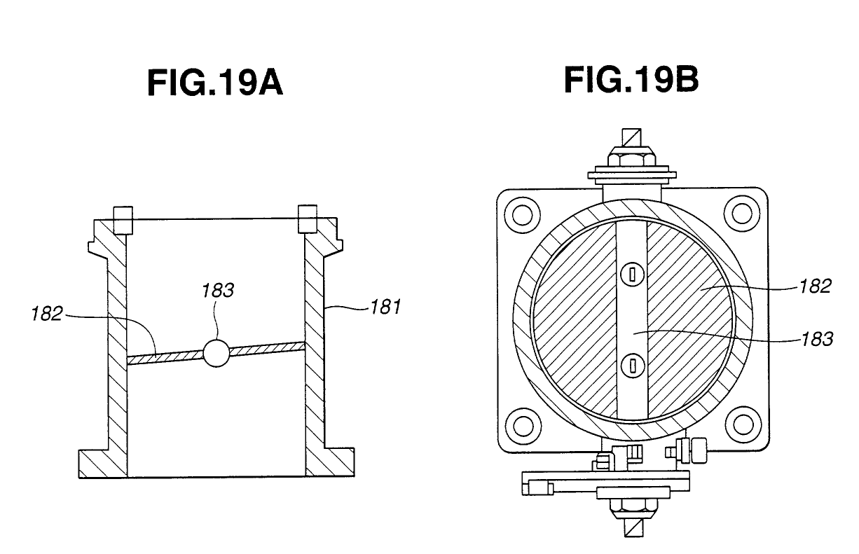

Although a molded or formed product having movable and unmovable portions according to this invention can be made if its movable and unmovable portions are separately prepared by, for example, injection molding, and put together, its movable and unmovable portions are preferably made as an integral combination by, for example, two-color molding. In this way, it is possible to achieve a still higher level of gas tightness and a reduction in the number of process steps and parts. A throttle chamber is shown in FIGS. 19A and 19B, and can be manufactured by, for example, a process which will now be described.

The throttle chamber has a cylindrical chamber portion 181 as an unmovable portion, a valve 182 as a movable portion and a metal shaft 183 for the valve. The metal shaft for the valve is first set in a mold for two-color molding, the cylindrical chamber portion is made by injection molding, a slide core is retracted for molding the circular valve, and the circular valve is made by injection molding. The metal shaft and the circular valve are united as an integral combination. This invention is also preferred for application to a cylindrically molded product having an unmovable portion for introducing a flowing gas, and a movable portion defining a cover to be opened or closed for controlling the flow of the gas.

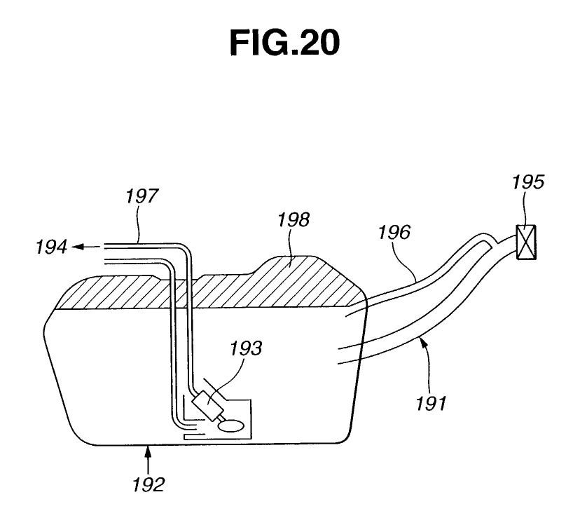

Owing to its excellent property of shutting off any hydrocarbon fuel, its excellent property as a gas barrier and its high chemical resistance, the resin composition of this invention is suitable for a part or container for holding any hydrocarbon fuel, such as a fuel tank or any other part of a fuel supply system in an automotive vehicle, or an item for domestic use, such as kerosene container. FIG. 20 shows a resinous fuel tank in a motor, or other vehicle, as such a part or container. It shows a fuel supply system in which gasoline, which is a hydrocarbon fuel, is introduced through a filler tube 191 for storage in a fuel tank 192, and is forced by a fuel pump 193 into an engine 194. The resin composition of this invention is applicable to parts for the fuel supply system, such as fuel tank 192, a filler cap 195, a vent tube 196, a fuel hose 197, a fuel cutoff valve, a delivery valve, an evaporation tube, a return tube and a fuel sender module. The fuel tank is the largest of the parts for the fuel supply system in the vehicle. There has recently been an increasing use of a resinous material for fuel tanks, and owing to an increased freedom available in the selection of shapes for parts, a resinous tank can hold about 10 liters more fuel than a metallic one, and is about 25% lighter in weight. These advantages have brought about greater expectations for resinous fuel tanks. The following is a detailed statement of the present status of the use of a resinous material for fuel tanks and the problems involved therein.

It has been usual to use HDPE (high density polyethylene), an olefin resin, as a matrix resin for a fuel tank and blow molding as a process for manufacturing it. While there has not been any great change in such material or process, there has been a great change in the layer structure of the tank. For example, the fuel tank was at first of the single layer type, but the enactment of the law for restraining the evaporation of hydrocarbons has made it essential to form a fuel tank with a multi-layer wall for reducing the permeation of hydrocarbons. As a result, fuel tanks are now mainly of a multi-layer wall structure composed of five layers of three kinds of materials, i.e. a mixture of HDPE and PA (polyamide), a mixture of HDPE and EVOH (ethylene-vinyl acetate copolymer) and HDPE on both sides. They are made by blow molding as usual.

The permeation of a large amount of hydrocarbon fuel through the wall of a single-layer type fuel tank is apparently due to good compatibility between the material of the tank and the fuel. HDPE has a solubility parameter of 7.9, while the hydrocarbon fuel has a SP of 6 to 8, and their SP's fall within the same range. On the other hand, PA used in the wall of a multi-layer type tank has a SP of 13.6 differing greatly from that of the fuel, or in other words, they are low in compatibility. Thus, the PA material in a multi-layer type fuel tank is employed as a barrier layer for preventing the escape of hydrocarbon fuel from the tank by permeation. The development of a multi-layer fuel tank has made it possible to establish a technique for satisfying the law for restraining the evaporation of hydrocarbons, but has brought about a sharp increase in price of such tanks due to the complicated molding process which they require. Moreover, the laminated structure formed by a plurality of resins is not easy to recycle, but has presented a new problem in failing to cope with the current requirements of a recycling society.

The linked fine inorganic particles in the resin composition of this invention has a SP exceeding 11 owing to the remaining silanol groups, and acts as a barrier against the permeation of hydrocarbon fuel like PA or EVOH as mentioned above. The resin composition consists mainly of a resin containing polar groups, such as acrylic, and having a SP above 11, which is low in compatibility with gasoline as hydrocarbon fuel, and a desirable material for fuel tanks. Thus, the resin composition of this invention has been found to provide a fuel tank for a vehicle which satisfies legal regulations concerning the evaporation of hydrocarbons, even if it may be of the type having a single-layer wall. It has enabled a fuel tank to be manufactured at a low cost and also respond to the social requirements for recycling. The resin composition of this invention is applicable not only to a fuel tank for a vehicle, but also to an article for domestic use, such as a kerosene container. It reduces the evaporation of kerosene into the air and contributes to preserving a sound global environment.

### EXAMPLES

The invention will now be described more specifically by examples. This invention is, however, not limited thereto. The following is an explanation of methods employed for various kinds of evaluation in Examples and Comparative Examples, in which ‘parts’ and ‘%’ are both indicated by weight, unless otherwise noted.

### EVALUATION 1

### Evaluation For Single-layer Transparent Resin Composition

(1) The total light transmittance was measured by a Haze meter (HM-65 of Murakami Color Research Institute). A value of 75% or above was accepted.

(2) The distribution state of linked fine inorganic particles was observed by a transmission electron microscope (H-800 of Hitachi, Ltd.).

(3) The bending strength and elastic modulus were measured by an Autograph (DCS-10T of Shimadzu Corporation). A bending strength of 108 MPa or above was accepted.

(4) The coefficient of linear expansion was measured by a thermomechanical measuring instrument (TMA120C of Seiko Instruments Inc.).

### EVALUATION 2

### Evaluation For Laminate

(1) The total light transmittance was measured by a Haze meter (HM-65 of Murakami Color Research Institute). The evaluation was made as G (good): ≧90 and NG (not good): <90.

(2) The Rockwell hardness was measured by a Rockwell hardness meter (M scale). The evaluation was made as G (good): ≧95 and NG (no good) <95.

(3) The bending modulus was measured by an Autograph (DCS-10T of Shimadzu Corporation). The evaluation was made as G (Good): ≧3500 MPa and NG (no good): <3500 MPa.

(4) Impact resistance: A 200 mm square laminate was fixed along all of its peripheral edges by a 180 mm square frame. Then, a steel ball conforming to the JIS-R3212 impact resistance test method was allowed to fall from different heights onto the laminate, and the height which caused cracking was determined. The evaluation was made as G(good): ≧3 m and NG(not good): <3 m.

(5) Separation of layers: Each laminate was bent by about 90 degrees and was visually inspected for any separation of layers. The evaluation was made as G (good): No separation, and NG (no good): Separation found.

(6) Distortion: A test specimen measuring 100 mm by 50 mm was cut out from each laminate to be tested and was subjected 10 times to a cycle consisting of heating at 110 deg. C. for two hours in an oven and allowing it to cool for at least two hours at room temperature. Thereafter, the test specimen was visually inspected for distortion. This evaluation was conducted on each of the three test specimens (n=3). The evaluation was made as G (good): No distortion, and NG (no good): Distortion found.

### Example 1

A nuclear sol (having a diameter of about 5 nm) was prepared from sodium silicate (water glass) by removing sodium from it by ion exchange and its fine particles were grown alone in a liquid to form chain silica having a thickness of 5 to 10 nm and a length of 90 to 350 nm. Alkyl groups were added to the chain silica by treatment with a silylating agent and it was dissolved in methyl ethyl ketone to prepare a silica solution.

AIBN, a polymerization initiator, was added in the amount of 0.5 mol % to a methyl methacrylate monomer solution(containing 1 mol of the monomer per 1 liter of methyl ethyl ketone solvent) to form a mixture solution. Then, the mixture solution was heated to 80 deg. C. (° C.), and the silica solution as prepared above was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. The resin composition containing fine silica particles linked in chain form showed a high bending modulus as compared with a methacrylic resin containing fine spherical silica particles. Table 1 shows the results obtained from the test specimen in respect of the total light transmittance, the distribution observed by a transmission electron microscope, the Rockwell hardness, the bending strength, the bending modulus and the coefficient of linear expansion.

### Example 2

A nuclear sol (having a diameter of about 5 nm) was prepared from sodium silicate (water glass) by removing sodium from it by ion exchange and its fine particles were grown alone in a liquid to form net silica constituting of chain silica having a thickness of 5 to 10 nm and a length of 90 to 350 nm. Alkyl groups were added to the chain silica by treatment with a silylating agent and it was dissolved in methyl ethyl ketone to prepare a silica solution.

AIBN, a polymerization initiator, was added in the amount of 0.5 mol % to a methyl methacrylate monomer solution(containing 1 mol of the monomer per 1 liter of methyl ethyl ketone solvent) to form a mixture solution. Then, the mixture solution was heated to 80 deg. C. (° C.), and the silica solution as prepared above was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. It showed better results as having a lower coefficient of linear expansion than the composition according to Example 1. The resin composition containing fine silica particles linked in net form showed a high bending modulus as compared with a methacrylic resin containing fine spherical silica particles. Table 1 shows the results obtained from the test specimen in respect of the total light transmittance, the distribution observed by a transmission electron microscope, the Rockwell hardness, the bending strength, the bending modulus and the coefficient of linear expansion.

### Example 3

AIBN, a polymerization initiator, was added in the amount of 0.5 mol % to a methyl methacrylate monomer solution(containing 1 mol of the monomer per 1 liter of methyl ethyl ketone solvent) to form a mixture solution. The mixture solution was heated to 80 deg. C., and a dispersion in methyl ethyl ketone solvent of masses of fine silica particles linked in chain form (having a thickness of 5 to 10 nm and a length of 30 to 80 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. It was, however, lower in bending strength than the resin composition according to Example 1. This was due to the small length of the masses of linked fine silica particles. The resin composition containing masses of fine silica particles linked in chain form, however, showed a high bending modulus as compared with a methacrylic resin containing fine spherical silica particles. Table 1 shows the results obtained from the test specimen in respect of its total light transmittance, distribution observed by a transmission electron microscope, Rockwell hardness, bending strength, bending modulus and coefficient of linear expansion.

### Example 4

AIBN, a polymerization initiator, was added in the amount of 0.5 mol % to a methyl methacrylate monomer solution(containing 1 mol of the monomer per 1 liter of methyl ethyl ketone solvent) to form a mixture solution. The mixture solution was heated to 80 deg. C., and a dispersion in methyl ethyl ketone solvent of masses of fine silica particles linked in chain form (having a thickness of 5 to 10 nm and a length of 350 to 500 nm) and subjected to a hydrophobicity-providing treatment with alkyl groups was gradually dropped into the mixture solution to cause a polymerization reaction. After about six hours, ethanol was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, though it was inferior to a methacrylic resin, and it showed an improvement in surface hardness, bending strength and bending modulus and a lowering in coefficient of linear expansion as compared with a methacrylic resin alone. It was, however, lower in transparency due to its lower distribution of masses, and was somewhat lower in hardness, too, than Example 1, though it was higher in bending strength. This was due to the linked fine silica particles having a length greater than the wavelength of visible light. The resin composition containing fine silica particles linked in chain form, however, showed a high bending modulus as compared with a methacrylic resin containing fine spherical silica particles. Table 1 shows the results obtained from the test specimen in respect of the total light transmittance, the distribution observed by a transmission electron microscope, the Rockwell hardness, the bending strength, the bending modulus and the coefficient of linear expansion.

### Example 5

AIBN, a polymerization initiator, was added in the amount of 0.5 mol % to a methyl methacrylate monomer solution(containing 1 mol of the monomer per 1 liter of methyl ethyl ketone solvent) to form a mixture solution. The mixture solution was heated to 80 deg. C., and a dispersion in methyl ethyl ketone solvent of masses of fine silica particles linked in chain form (having a thickness of 1 to 5 nm, and a length of 90 to 350 nm; each fine silica particle having a length or diameter of 7 to 50 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. Table 1 shows the results obtained from the test specimen in respect of the total light transmittance, the distribution observed by a transmission electron microscope, the Rockwell hardness, the bending strength, the bending modulus and the coefficient of linear expansion.

### Example 6

AIBN, a polymerization initiator, was added in the amount of 0.5 mol % to a methyl methacrylate monomer solution(containing 1 mol of the monomer per 1 liter of methyl ethyl ketone solvent) to form a mixture solution. The mixture solution was heated to 80 deg. C., and a dispersion in methyl ethyl ketone solvent of masses of fine silica particles linked in chain form (having a thickness of 10 to 20 nm, and a length of 90 to 350 nm; each fine silica particle having a length or diameter of 7 to 50 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. Table 1 shows the results obtained from the test specimen in respect of the total light transmittance, the distribution observed by a transmission electron microscope, the Rockwell hardness, the bending strength, the bending modulus and the coefficient of linear expansion.

### Example 7

AIBN, a polymerization initiator, was added in the amount of 0.5 mol % to a methyl methacrylate monomer solution(containing 1 mol of the monomer per 1 liter of methyl ethyl ketone solvent) to form a mixture solution. The mixture solution was heated to 80 deg. C., and a dispersion in methyl ethyl ketone solvent of masses of fine silica particles linked in chain form (having a thickness of 10 to 20 nm, and a length of 50 to 350 nm; each fine silica particle having a length or diameter of 50 to 100 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. Table 1 shows the results obtained from the test specimen in respect of the total light transmittance, the distribution observed by a transmission electron microscope, the Rockwell hardness, the bending strength, the bending modulus and the coefficient of linear expansion.

### Example 8

AIBN, a polymerization initiator, was added in the amount of 0.5 mol % to a methyl methacrylate monomer solution(containing 1 mol of the monomer per 1 liter of methyl ethyl ketone solvent) to form a mixture solution. The mixture solution was heated to 80 deg. C., and a dispersion in methyl ethyl ketone solvent of masses of fine silica particles linked in chain form (having a thickness of 10 to 20 nm, and a length of 100 to 350 nm; each fine silica particle having a length or diameter of 50 to 100 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. Table 1 shows the results obtained from the test specimen in respect of the total light transmittance, the distribution observed by a transmission electron microscope, the Rockwell hardness, the bending strength, the bending modulus and the coefficient of linear expansion.

### Example 9

A dispersion in methyl ethyl ketone solvent of fine silica particles linked in chain form (having a thickness of 5 to 10 nm and a length of 90 to 350 nm) and subjected to hydrophobicity-providing treatment with alkyl groups was gradually dropped into and mixed with a solution containing 100 parts by weight of polymethyl methacrylate so as to form a mixture solution. Thereafter, hexane was added as a solidifying solvent to the mixture solution to cause sedimentation thereby to yield a mixed or resin composition containing linked fine silica particles and a methacrylic resin in a weight ratio of 30/70.

The resin composition as obtained was dried and hot press formed to prepare a test specimen. The test specimen was low in transparency, but showed an improvement in surface hardness, bending strength and bending modulus and a lowering in coefficient of linear expansion as compared with a methacrylic resin alone. Because of its poor distribution of masses of linked fine silica particles, however, it was inferior to the composition according to Example 1 in transparency, hardness, bending strength and bending modulus. The resin composition containing fine silica particles linked in chain form, however, showed a high bending modulus as compared with a methacrylic resin containing fine spherical silica particles. Table 2 shows the results obtained from the test specimen in respect of the total light transmittance, the distribution observed by a transmission electron microscope, the Rockwell hardness, the bending strength, the bending modulus and the coefficient of linear expansion.

### Example 10

AIBN, a polymerization initiator, was added in the amount of 0.5 mol % to a methyl methacrylate monomer solution(containing 1 mol of the monomer per 1 liter of methyl ethyl ketone solvent) to form a mixture solution. A dispersion in methyl ethyl ketone solvent of masses of fine silica particles linked in chain form (having a thickness of 5 to 10 nm, and a length of 90 to 350 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 10/90.

The resin composition as obtained was dried and hot press formed to prepare a test specimen. The test specimen was good in transparency, and showed an improvement in surface hardness, bending strength and bending modulus and a lowering in coefficient of linear expansion as compared with a methacrylic resin alone. It was, however, hardly improved over the composition according to Example 1 in bending strength, bending modulus, hardness or coefficient of linear expansion. This was due to the low proportion of the masses of linked fine silica particles. The resin composition containing fine silica particles linked in chain form, however, showed a high bending modulus as compared with a methacrylic resin containing fine spherical silica particles. Table 2 shows the results obtained from the test specimen in respect of the total light transmittance, the distribution observed by a transmission electron microscope, the Rockwell hardness, the bending strength, the bending modulus and the coefficient of linear expansion.

### Example 11

AIBN, a polymerization initiator, was added in the amount of 0.5 mol % to a methyl methacrylate monomer solution(containing 1 mol of the monomer per 1 liter of methyl ethyl ketone solvent) to form a mixture solution. A dispersion in methyl ethyl ketone solvent of masses of fine silica particles linked in chain form (having a thickness of 5 to 10 nm, and a length of 90 to 350 nm) and subjected to a hydrophobicity-providing treatment with alkyl groups was gradually dropped into the mixture solution to cause a polymerization reaction. After about six hours, hexane was added as a solidifying solvent to the mixture solution to cause sedimentation thereby to yield a mixed or resin composition containing linked fine silica particles and a methacrylic resin in a weight ratio of 70/30.

The resin composition as obtained was dried and hot press formed to prepare a test specimen. The test specimen was low in transparency and bending strength, but showed an improvement in surface hardness and bending modulus and a lowering in coefficient of linear expansion as compared with a methacrylic resin alone.

It was, however, inferior to the composition according to Example 1 in transparency and bending strength. This was due to so high a proportion of the linked fine silica particles that resulted in an increase of their coagulation and defects. The resin composition containing fine silica particles linked in chain form, however, showed a high bending modulus as compared with a methacrylic resin containing fine spherical silica particles. Table 2 shows the results obtained from the test specimen in respect of the total light transmittance, the distribution observed by a transmission electron microscope, the Rockwell hardness, the bending strength, the bending modulus and the coefficient of linear expansion.

### Comparative Example 1

A mixture of 100 parts by weight of methyl methacrylate and 0.5 part by weight of benzoyl peroxide was heated to 90 deg. C., and a dispersion of fine silica particles (having a particle diameter of 10 to 20 nm) in methyl ethyl ketone solvent was gradually dropped into the mixture to cause a polymerization reaction. After about an hour, ethanol was added as a solidifying solvent to the mixture so as to cause sedimentation thereby to yield a mixed or resin composition containing fine silica particles and a methacrylic resin in a weight ratio of 30/70.

The resin composition as obtained was dried and hot press formed to prepare a test specimen. The test specimen was good in transparency, but showed a low bending modulus as compared with any of the methacrylic resins containing fine silica particles linked in chain form according to Examples 1 to 7. Table 2 shows the results obtained from the test specimen in respect of the total light transmittance, the Rockwell hardness, the bending strength, the bending modulus and the coefficient of linear expansion.

### Comparative Example 2

A mixture of 100 parts of methyl methacrylate and 0.5 part of benzoyl peroxide was heated to 90 deg. C. to undergo a polymerization reaction. After about an hour, ethanol was added as a solidifying solvent to the mixture so as to cause sedimentation thereby to yield a methacrylic resin.

The resin as obtained was dried and hot press formed to prepare a test specimen. Table 2 shows the results obtained from the test specimen in respect of the total light transmittance, the Rockwell hardness, the bending strength, the bending modulus and the coefficient of linear expansion.

### Example 12

A laminate was prepared from the resin composition according to Example 1 and a polycarbonate resin (Iupilon E200U of Mitsubishi Engineering-Plastics Corporation) by using two extruders and a T-die having three slits. The laminate was a three-layer structure composed of an upper layer of an acrylic resin containing silica [the resin composition (A)], a middle layer of a polycarbonate resin not containing silica [the resin (B)] and a lower layer of the same acrylic resin containing silica as the upper layer [the resin composition (A)], in which the upper, middle and lower layers were respectively 1, 3 and 1 mm in thickness. The resin composition (A) contained 30% by weight of the linked fine inorganic particles. The results of evaluation are shown in Table 3.

### Example 13

A procedure of Example 12 was repeated to prepare a laminate with the exception that the linked fine inorganic particles in the proportion of 1% by weight was contained in the resin (A). The laminate was likewise evaluated. The results are shown in Table 3.

### Example 14

A procedure of Example 12 was repeated to prepare a laminate with the exception that the linked fine inorganic particles in the proportion of 10% by weight was contained in the resin (A). The laminate was likewise evaluated. The results are shown in Table 3.

### Example 15

A procedure of Example 12 was repeated to prepare a laminate with the exception that the discharge capacity of the extruders was lowered and the widths of slits of the T-dies were changed to form the upper layer of the resin composition (A) having a thickness of 0.1 mm, the middle layer of resin (B) having a thickness of 0.3 mm and the lower layer of resin composition (A) having a thickness of 0.1 mm. The laminate was likewise evaluated. The results are shown in Table 3.

### Example 16

A procedure of Example 12 was repeated to prepare a laminate with the exception that the discharge capacity of the extruders was increased and the widths of slits of the T-dies were changed to form the upper layer of the resin composition (A) having a thickness of 2 mm, the middle layer of resin (B) having a thickness of 6 mm and the lower layer of the resin composition (A) having a thickness of 2 mm. The laminate was likewise evaluated. The results are shown in Table 3.

### Example 17

A procedure of Example 12 was repeated to prepare a laminate with the exception that the linked fine inorganic particles having a length of 200 to 250 nm was used, and 5% by weight of the linked fine inorganic particles was contained in the resin composition. The laminated was likewise evaluated. The results are shown in Table 3.

### Example 18

A procedure of Example 12 was repeated to prepare a laminate with the exception that the discharge capacity of the extruders was adjusted and T-dies adapted to form a laminate of five layers are employed, the five layers including alternate layers of the resin composition (A) and the resin (B). The arrangement of the layers was the resin composition A/ the resin B/ the resin composition A/ the resin B/ the resin composition A, and the layers were respectively 0.7, 1.5, 0.6, 1.5 and 0.7 mm in thickness. The laminate was likewise evaluated. The results are shown in Table 3.

### Comparative Example 3

A procedure of Example 12 was repeated to prepare a three-layer laminate having a 5 mm thickness with the exception that an acrylic resin not containing any linked fine inorganic particles (referred to as resin C) was used in place of the resin composition A. The laminate was likewise evaluated. The results are shown in Table 3.

### EVALUATION RESULTS

The resin composition containing the linked fine silica particles according to any of Examples 1 to 7 of this invention was of higher rigidity, lower thermal expansibility and higher surface hardness than the transparent resin alone, without lowering its light transmittance, as the linked fine silica particles smaller in length than the wavelength of visible light could be dispersed uniformly in the transparent non-crystalline resin without undergoing coagulation. Moreover, the resin composition according to this invention showed a higher bending modulus than that of the methacrylic resin containing fine spherical silica particles.

As is obvious from Examples 8 to 14, the lamination of the resin composition according to this invention could make a molded or formed product of high impact resistance and resisting distortion at an elevated temperature.

Thus, the resin composition can be employed to make a molded or formed product having the characteristics as stated above with a wide range of freedom in the selection of designs by injection, extrusion or blow molding. Although a window of inorganic glass for an automotive vehicle requires a machine finish along its edges, an injection-molded window does not require any machining along its edges, but provides an improved productivity.

The entire contents of Japanese Patent Application P2001-334591 (filed Oct. 31, 2001) and Japanese Patent Application P2002-188416 (filed Jun. 27, 2002) are incorporated herein by reference.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

TABLE 1

| | Example 1 | Example 2 | Example 3 | Example 4 | Example 5 | Example 6 | Example 7 | Example 8 |
|---|---|---|---|---|---|---|---|---|
| Manufacturing | Batch type | Batch type | Batch type | Batch type | Batch type | Batch type | Batch type | Batch type |
| process | polymerization | polymerization | polymerization | polymerization | polymerization | polymerization | polymerization | polymerization |
| Monomer | Methyl | Methyl | Methyl | Methyl | Methyl | Methyl | Methyl | Methyl |
| | methacrylate | methacrylate | methacrylate | methacrylate | methacrylate | methacrylate | methacrylate | methacrylate |
| Thickness of | 5-10 | 5-10 | 5-10 | 5-10 | 1-5 | 10-20 | 10-20 | 10-20 |
| linked fine | | | | | | | | |
| inorganic | | | | | | | | |
| particles | | | | | | | | |
| (nm) | | | | | | | | |
| Length of fine | 7-50 | 7-50 | 7-50 | 7-50 | 7-50 | 7-50 | 50-100 | 50-100 |
| inorganic | | | | | | | | |
| particle | | | | | | | | |
| (nm) | | | | | | | | |
| Length of | 90-350 | 90-350 | 30-80 | 350-500 | 90-350 | 90-350 | 50-350 | 100-350 |
| linked fine | | | | | | | | |
| inorganic | | | | | | | | |
| particles | | | | | | | | |
| (nm) | | | | | | | | |
| Shape of linked | Chain | Net | Chain | Chain | Chain | Chain | Chain,, | Chain, |
| fine inorganic | | | | | | | | |
| particle | | | | | | | | |
| Functional | Alkyl group | Alkyl group | Alkyl group | Alkyl group | Alkyl group | Alkyl group | Alkyl group | Alkyl group |
| group at the | | | | | | | | |
| surfaces of | | | | | | | | |
| linked fine | | | | | | | | |
| inorganic | | | | | | | | |
| particles | | | | | | | | |
| Proportion of | 30 | 30 | 30 | 30 | 30 | 30 | 30 | 30 |
| linked fine | | | | | | | | |
| inorganic | | | | | | | | |
| particles | | | | | | | | |
| (wt %) | | | | | | | | |
| Total light | 92 | 92 | 92 | 84 | 92 | 92 | 92 | 92 |
| transmittance | | | | | | | | |
| (%), | | | | | | | | |
| Distribution | Very good | Very good | Very good | Good | Very good | Very good | Very good | Very good |
| observed by a | | | | | | | | |
| transmission | | | | | | | | |
| electron | | | | | | | | |
| microscope | | | | | | | | |
| Rockwell | 115 | 115 | 115 | 105 | 115 | 115 | 115 | 115 |
| hardness | | | | | | | | |
| (M scale) | | | | | | | | |
| Bending | 125 | 125 | 120 | 135 | 125 | 125 | 120 | 130 |
| strength (MPa) | | | | | | | | |
| Bending | 4.4 | 4.4 | 4.4 | 4.4 | 4.4 | 4.4 | 4.4 | 4.4 |
| modulus (GPa) | | | | | | | | |
| Coefficient of | 4.5 × 10⁻⁵ | 4.3 × 10⁻⁵ | 4.5 × 10⁻⁵ | 4.5 × 10⁻⁵ | 4.5 × 10⁻⁵ | 4.5 × 10⁻⁵ | 4.5 × 10⁻⁵ | 4.5 × 10⁻⁵ |
| linear | | | | | | | | |
| expansion | | | | | | | | |
| (1/° C.) | | | | | | | | |

TABLE 2

| | Example 9 | Example 10 | Example 11 | Comparative Example 1 | Comparative Example 2 |
|---|---|---|---|---|---|
| Manufacturing process | Solvent mixing | Batch type | Batch type | Batch type | Batch type |
| | | polymerization | polymerization | polymerization | polymerization |
| Monomer | Methyl methacyrlate | Methyl methacyrlate | Methyl methacyrlate | Methyl methacyrlate | methyl methacyrlate |
| Thickness of linked fine | 5-10 | 5-10 | 5-10 | Diameter | — |
| inorganic particles (nm) | | | | 10-20 (nm) | |
| Length of fine inorganic | 7-50 | 7-50 | 7-50 | | — |
| particles (nm) | | | | | |
| Length of linked fine | 90-350 | 90-350 | 90-350 | | — |
| inorganic particles (nm) | | | | | |
| Shape of linked fine | Chain | Chain | Chain | Spherical | — |
| inorganic particles | | | | | |
| Functional group at the | Alkyl group | Alkyl group | Alkyl group | Alkyl group | — |
| surfaces of linked fine | | | | | |
| inorganic particles | | | | | |
| Proportion of linked fine | 30 | 10 | 70 | 30 | — |
| inorganic particles (wt %) | | | | | |
| Total light transmittance | 85 | 92 | 85 | 92 | 93 |
| (%), | | | | | |
| Distribution observed by a | Coagulation found | Very good | Coagulation found | Very good | — |
| transmission electron | | | | | |
| microscope | | | | | |
| Rockwell hardness | 105 | 105 | 120 | 110 | 100 |
| (M scale) | | | | | |
| Bending strength (MPa) | 115 | 115 | 100 | 120 | 110 |
| Bending modulus (GPa) | 4.3 | 3.6 | 4.5 | 3.2 | 3.1 |
| Coefficient of linear | 4.5 × 10⁻⁵ | 4.8 × 10⁻⁵ | 4.5 × 10⁻⁵ | 4.6 × 10⁻⁵ | 6.0 × 10⁻⁵ |
| expansion (1/° C.) | | | | | |

TABLE 3

| | | | | | | | | Comparative |
|---|---|---|---|---|---|---|---|---|
| | Example 12 | Example 13 | Example 14 | Example 15 | Example 16 | Example 17 | Example 18 | Example 3 |
| Sample | | | | | | | | |
| Number of | 3 | 3 | 3 | 3 | 3 | 3 | 5 | 3 |
| layers | | | | | | | | |
| Layer | A/B/A | ← | ← | ← | ← | ← | A/B/A/B/A | C/B/C |
| arrangement | | | | | | | | |
| (*1) | | | | | | | | |
| Laminate | 5 | 5 | 5 | 0.5 | 10 | 5 | 5 | 5 |
| thickness (mm) | | | | | | | | |
| Proportion of | 30 | 1 | 10 | 30 | 30 | 30 | 30 | 30 |
| fine inorganic | | | | | | | | |
| particles (wt %) | | | | | | | | |
| Evaluation | | | | | | | | |
| Total light | G | G | G | G | G | G | G | G |
| transmittance | | | | | | | | |
| Rockwell | G | G | G | G | G | G | G | NG |
| hardness | | | | | | | | |
| Bending | G | G | G | G | G | G | G | G |
| modulus | | | | | | | | |
| Impact | G | G | G | G | G | G | G | G |
| resistance | | | | | | | | |
| Layer separation | G | G | G | G | G | G | G | NG |
| Distortion | G | G | G | G | G | G | G | NG |
| Overall evaluation | G | G | G | G | G | G | G | G |

*1: Layer A - Acrylic resin containing linked fine inorganic particles subjected to a hydrophobic treatment; Layer B - Polycarbonate resin (not containing any linked fine inorganic particles subjected to hydrophobic treatment); Layer C - Acrylic resin (not containing any linked fine inorganic particles subjected to hydrophobic treatment).

What is claimed is:

1. A resin composition comprising:
a resin; and
linkages of inorganic fine particles dispersed uniformly in the resin, each linkage having hydroxyl groups and hydrophobic groups, the linkages taking at least one of a chain-like form and a net-like form.

2. A resin composition as claimed in claim 1, wherein each linkage has a maximum length of not larger than 380 nm.

3. A resin composition as claimed in claim 1, wherein each linkage has a length/thickness ratio ranging from 2.5 to 350.

4. A resin composition as claimed in claim 1, wherein each fine inorganic particle has a thickness ranging from 1 to 20 nm.

5. A resin composition as claimed in claim 1, wherein each fine inorganic particle has a length ranging from 7 to 200 nm.

6. A resin composition as claimed in claim 1, wherein the linkages of the fine inorganic particles is contained in an amount ranging from 1 to 99% by weight based on weight of the resin.

7. A resin composition as claimed in claim 1, wherein the linkage of the fine inorganic particles has alkyl groups at a surface of the linkage.

8. A resin composition as claimed in claim 1, wherein each fine inorganic particle includes silicon oxide.

9. A resin composition as claimed in claim 1, wherein the resin is of at least one transparent organic resin selected from the group consisting of acrylic resin, polycarbonate resin, polystyrene resin and polyolefin resin.

10. A thermoplastic resin laminate comprising:
at least one layer of the resin composition (A) of claim 1; and
at least one layer of a thermoplastic resin (B),
wherein each layer of the resin composition (A) and each layer of the thermoplastic resin (B) are alternately laminated on each other.

11. A thermoplastic resin laminate as claimed in claim 10, wherein each layer of the resin composition (A) and each layer of the thermoplastic resin (B) are thermally welded to each other.

12. A thermoplastic resin laminate as claimed in claim 10, wherein the thermoplastic resin (B) is polycarbonate resin.

13. A thermoplastic resin laminate as claimed in claim 10, wherein at least one layer of the resin composition (A) and at least one layer of the thermoplastic resin (B) constitute the thermoplastic resin laminate of not less than three layers and of an odd number.

14. An interior or exterior part of a vehicle, an outer panel of a vehicle or a resinous window of a vehicle, formed of the resin composition of claim 1 or the thermoplastic resin laminate of claim 10.

15. A method of producing the resin composition of claim 1, comprising:
preparing linkages of fine inorganic particles each having hydroxyl groups which linkages have been subjected to a hydrophobicity-providing treatment;
dispersing the linkages in a solvent to form a dispersion liquid;
dissolving a resin in a solvent to form a resinous solution; and
mixing the dispersion liquid and the resinous solution.

16. A method of producing the resin composition of claim 1, comprising:
preparing linkages of fine inorganic particles each having hydroxyl groups which linkages have been subjected to a hydrophobicity-providing treatment;
dispersing the linkages in a solvent to form a dispersion liquid; and
mixing the dispersion liquid with a resin during polymerization of the resin.

17. A method of producing the thermoplastic resin laminate of claim 10, wherein the thermoplastic resin laminate is formed under heat or under pressure.

18. A method of producing an interior or exterior part of a vehicle, comprising:
inserting the thermoplastic resin laminate of claim 10 into a metallic mold; and
filling a resin to be integral with an peripheral section of the thermoplastic resin laminate under an injection molding or a compression molding.

19. A resinous wiper system comprising the resin composition of claim 1.

20. A resinous door mirror stay comprising the resin composition of claim 1.

21. A resinous pillar comprising the resin composition of claim 1.

22. A resin formed product including a transparent portion and an opaque portion, at least the transparent portion comprising the resin composition of claim 1.

23. A resin formed product as claimed in claim 22, wherein the transparent portion and the opaque portion are formed integral with each other.

24. A resin formed product as claimed in claim 22, wherein the opaque portion is formed by being colored with a pigment dispersed in a resin forming the opaque portion.

25. A resin formed product as claimed in claim 22, wherein the opaque portion is formed by painting or printing made before or after formation of opaque portion.

26. A resin formed product as claimed in claim 22, wherein the opaque portion is formed by employing a colored sheet.

27. A window provided with a heating element, comprising the resin composition of claim 1.

28. A resinous mirror comprising the resin composition of claim 1.

29. A resinous lamp reflector comprising the resin composition of claim 1.

30. A resinous cover or case in an engine compartment, comprising the resin composition of claim 1.

31. A resinous cover or case as claimed in claim 30, wherein the resinous cover or case is transparent.

32. A resinous part of a cooling system, comprising the resin composition of claim 1.

33. A resinous integrally formed product having at least one of a hollow structure communicating with open air and a closed hollow structure which comprise the resin composition of claim 1.

34. A resinous integrally formed product as claimed in claim 33, comprising at least one of the hollow structure and the closed hollow structure is filled with at least one selected from the group consisting of gas, liquid, solid and a mixture thereof and is sealed.

35. A resinous integrally formed product as claimed in claim 33, comprising an outermost layer which is formed of an ornamental material.

36. A resinous integrally formed product as claimed in claim 33, wherein the resinous integrally formed product is an outer panel, an interior part or an exterior part of an automotive vehicle.

37. A method of producing a resinous integrally formed product of claim 33, comprising:
heating first and second resin sheets each comprising the resin composition of claim 1;
inserting the heated first and second resin sheets into a mold in an open state;
pressing outer peripheral sections of the first and second resin sheets;
introducing a pressurized fluid into between the first and second resin sheets before or after welding the outer peripheral sections of the first and second resin sheets; and
putting the mold in a closed state during or after expansion of the first and second sheets to keep the pressurized fluid between the first and second resin sheets so as to form a hollow structure.

38. A method of producing a resinous integrally formed product of claim 33, comprising:
filling the resin composition of claim 1 in a molten state into a mold in a closed state; and
introducing a pressurized fluid into the resin composition in the molten state enlarging volume of a cavity of the mold, during or after filling the resin composition, so as to form a hollow structure.

39. A method of producing a resinous integrally formed product of claim 33, comprising:
putting one or two resin sheets comprising the resin composition of claim 1 onto a surface of a cavity of a mold in an open state;
filling a molten resin into a location behind the one resin sheet or into a location between the two resin sheets in the mold in a closed state; and
introducing a pressurized fluid into the resin composition in the molten state enlarging volume of a cavity of the mold, during or after filling the resin composition, so as to form a hollow structure.

40. An integrally formed product comprising the resin composition of claim 1, the integrally formed product being a single part which is formed by combining not less than two parts which respectively have different functions so as to provide the single part with not less than two functions.

41. A formed product comprising a movable and an unmovable portion each of which including the resin composition of claim 1.

42. A formed product as claimed in claim 41, wherein the movable portion and the unmovable portion are formed as a single body by a two-color forming.

43. A formed product as claimed in claim 41, wherein the movable portion is a cover member to be opened and closed, and the unmovable portion is a cylindrical formed product through which gas flows.

44. A part or container for containing fuel of hydrocarbons, comprising the resin composition of claim 1.

45. A part or container as claimed in claim 44, wherein the part or contain forms part of a fuel supply system of a vehicle.

46. A part or container as claimed in claim 44, wherein the part or container is a fuel tank of a vehicle.

47. A part or container as claimed in claim 46, wherein the part or container is a fuel tank of a vehicle, formed by a blow molding.
